(19) United States
(12) Patent Application Publication
(10) Pub. No.: US 2024/0330077 A1
(43) Pub. Date: Oct. 3, 2024

(54) METHODS AND SYSTEMS THAT PROVIDE EFFICIENT CONTENTION CONTROL IN DISTRIBUTED COMPUTER SYSTEMS

(71) Applicant: VMware LLC, Palo Alto, CA (US)

(72) Inventor: Sankarasivasubramanian Pasupathilingam, Chennai (IN)

(73) Assignee: VMware LLC, Palo Alto, CA (US)

(21) Appl. No.: 18/129,568

(22) Filed: Mar. 31, 2023

(51) Int. Cl. G06F 9/52; G06F 9/54

(52) U.S. Cl. CPC G06F 9/52; G06F 9/544; G06F 9/546

(57) ABSTRACT

The current document is directed to contention control for computational resources in distributed computer systems and, in particular, to contention control for memory in distributed metrics collection systems that collect and aggregate metric data in distributed computer systems. In one implementation, parallel metric-data collectors in a first distributed computer system collect metric data and one or more aggregators aggregate collected metric data and forward the aggregated metric data to a second distributed computer system, which uses the metric data for various monitoring, analysis, and management tasks. Each parallel data collector stores received metrics in a metrics container assigned to the parallel collector and a write/read-write lock provides contention control that allows multiple metric-data collectors to concurrently access metrics containers but only a single aggregator to access the metrics containers.

### TECHNICAL FIELD

The current document is directed to distributed-computer-systems and, in particular, to systems, and methods incorporated within the systems, that provide efficient contention control for memory and other computational resources.

### BACKGROUND

During the past seven decades, electronic computing has evolved from primitive, vacuum-tube-based computer systems, initially developed during the 1940s, to modern electronic computing systems in which large numbers of multiprocessor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. The advent of distributed computer systems has provided a computational platform for increasingly complex distributed applications, including service-oriented applications. Distributed applications, including service-oriented applications and microservices-based applications, provide many advantages, including efficient scaling to respond to changes in workload, efficient functionality compartmentalization that, in turn, provides development and management efficiencies, flexible response to system component failures, straightforward incorporation of existing functionalities, and straightforward expansion of functionalities and interfaces with minimal interdependencies between different types of distributed-application instances. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems and applications have, in turn, become increasingly complex, involving greater computational overheads and significant inefficiencies and deficiencies. In fact, many desired management-and-administration functionalities are becoming sufficiently complex to render traditional approaches to the design and implementation of automated management and administration subsystems impractical, from a time and cost standpoint. Therefore, designers and developers of distributed computer systems and applications continue to seek new approaches to implementing automated management-and-administration facilities and functionalities.

### SUMMARY

The current document is directed to contention control for computational resources in distributed computer systems and, in particular, to contention control for memory in distributed metrics collection systems that collect and aggregate metric data in distributed computer systems. In one implementation, parallel metric-data collectors in a first distributed computer system collect metric data and one or more aggregators aggregate collected metric data and forward the aggregated metric data to a second distributed computer system, which uses the metric data for various monitoring, analysis, and management tasks. Each parallel data collector stores received metrics in a metrics container assigned to the parallel collector and a write/read-write lock provides contention control that allows multiple metric-data collectors to concurrently access metrics containers but only a single aggregator to access the metrics containers.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates a fundamental Kubernetes abstraction.

FIG. 12 illustrates a next level of abstraction provided by Kubernetes, referred to as a “Kubernetes cluster.”

FIG. 13 illustrates the logical contents of a pod.

FIG. 14 illustrates the logical contents of a Kubernetes management node and a Kubernetes worker node.

FIGS. 15A-E illustrate operation of a Kubernetes cluster.

FIG. 16 illustrates the Tanzu Kubernetes Grid (“TKG”) containerized-application automated orchestration system.

FIG. 17 illustrates a distributed-computing environment in which one implementation of the currently disclosed methods and systems is used to facilitate metrics collection.

FIG. 18 illustrates one process by which metric messages are sent from client Kubernetes cluster pods to the global controller-and-observer functionality in the management Tanzu cluster.

FIG. 19 illustrates the architecture for metrics generation and collection in a first metrics-generation-and-collection implementation of the distributed-computing environment shown in FIGS. 17-18.

FIG. 20 illustrates a typical metrics message.

FIG. 21 illustrates generation of aggregate metrics from received metric messages.

FIG. 22 illustrates an improved architecture for metrics generation and collection using the illustration conventions of FIG. 19.

FIG. 23 illustrates a further-improved architecture for metrics generation and collection.

FIGS. 24A-B illustrates a still-further-improved architecture for metrics generation and collection.

FIG. 25 illustrates additional details with respect to the final architecture for metrics generation and collection shown in FIG. 24B.

FIGS. 26A-E illustrate one implementation of the lock 2514 shown in FIG. 25.

FIGS. 27A-B provide an improved implementation of the local metrics collector and metrics aggregator within a client Kubernetes cluster of a Tanzu Service Mesh.

FIGS. 28A-H illustrate, using control-flow diagrams, one implementation of the WR lock.

FIG. 29 provides a control-flow diagram for the metrics-collector logic (2726 in FIG. 27B).

FIG. 30 provides a control-flow diagram for the aggregator logic.

### DETAILED DESCRIPTION

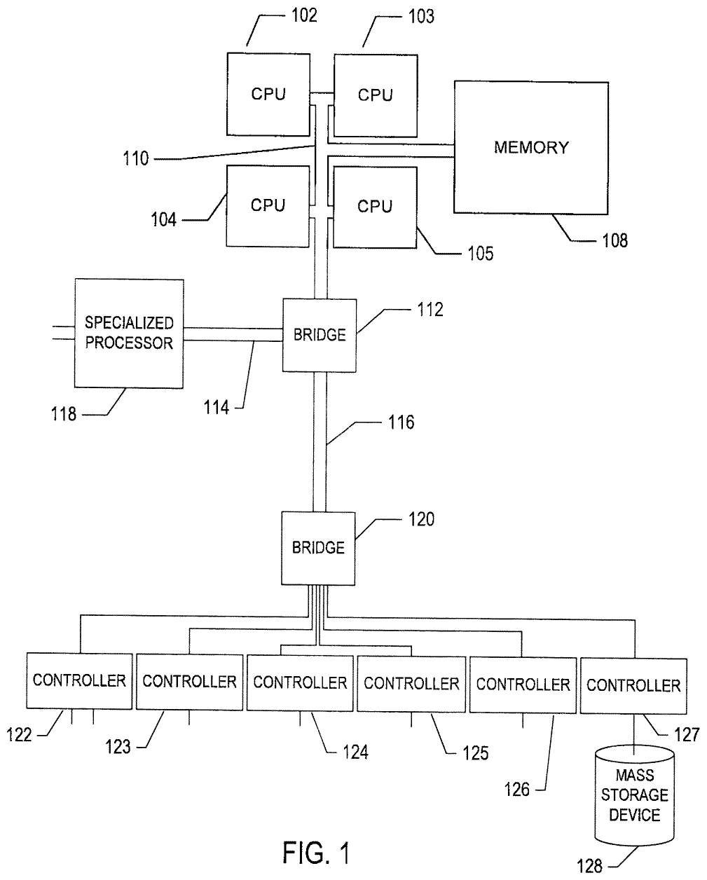

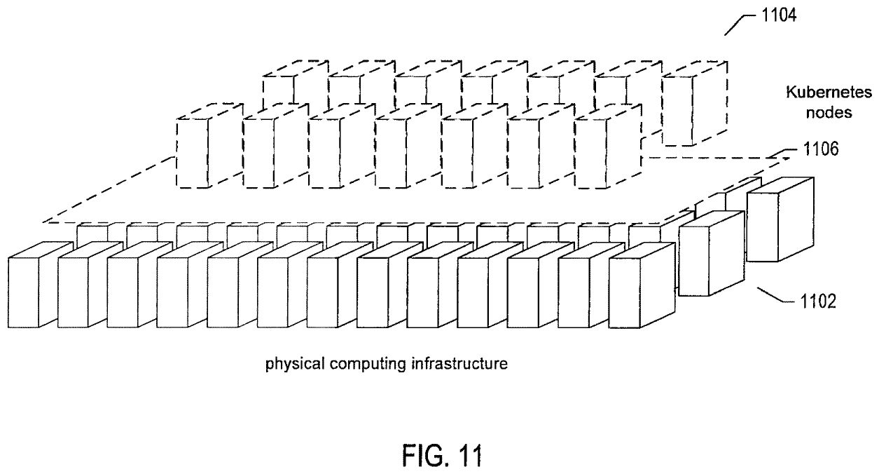

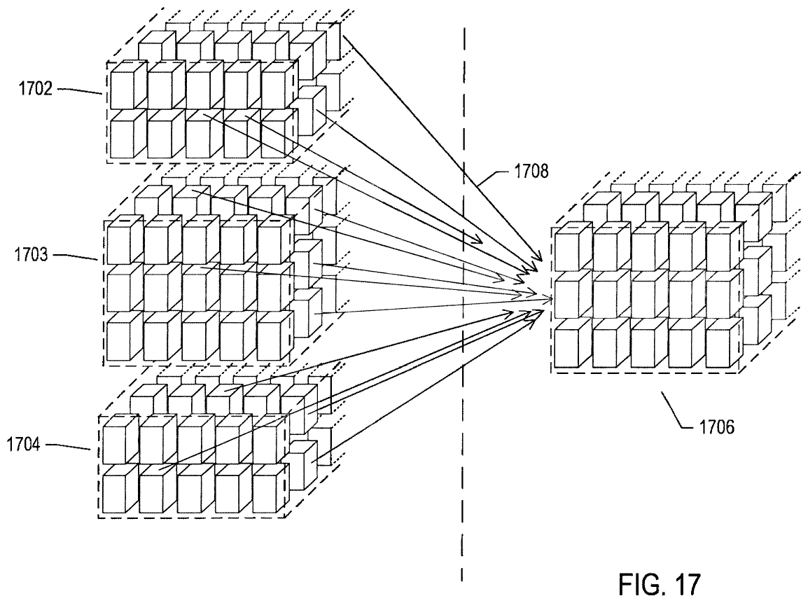

The current application is directed to distributed-computer-systems and, in particular, to systems, and methods incorporated within the systems, that provide efficient contention control for memory and other computational resources. In a first subsection, below, a detailed description of computer hardware, complex computational systems, and virtualization is provided with reference to FIGS. 1-10. In a second subsection, Kubernetes, a widely used automated orchestration system, is discussed with reference to FIGS. 11-16. Finally, in a third subsection, the currently disclosed methods and systems are discussed with reference to FIGS. 17-30.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

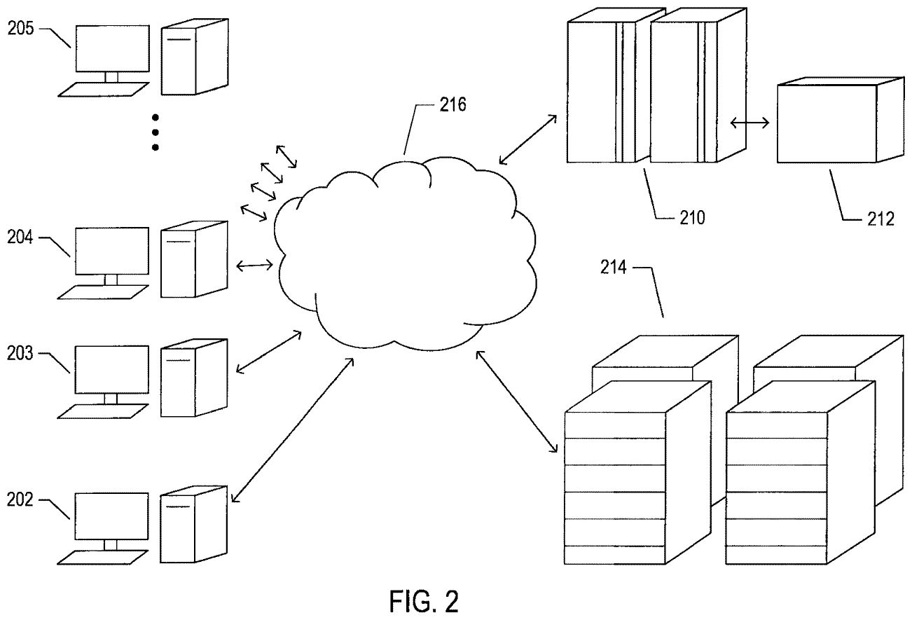

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

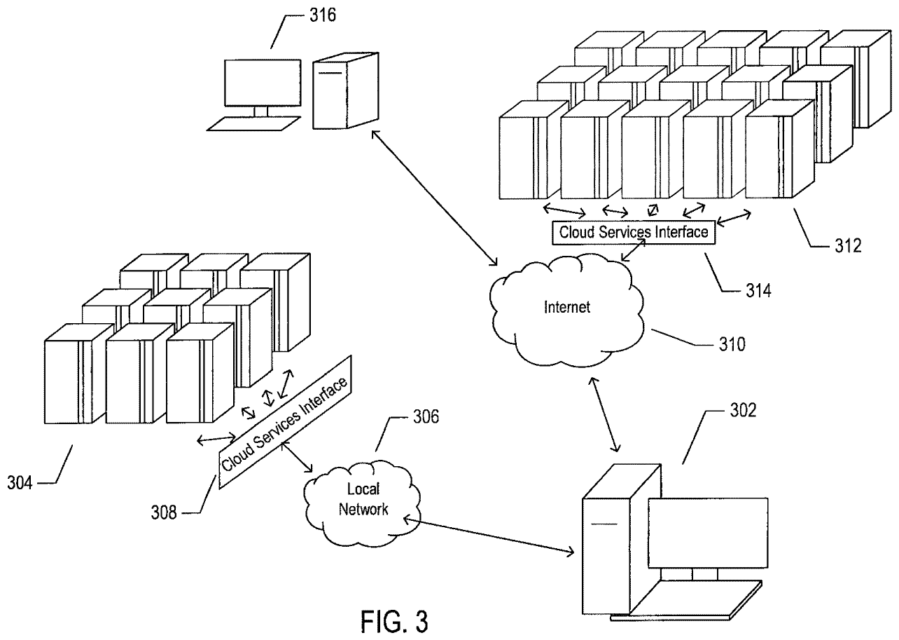

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

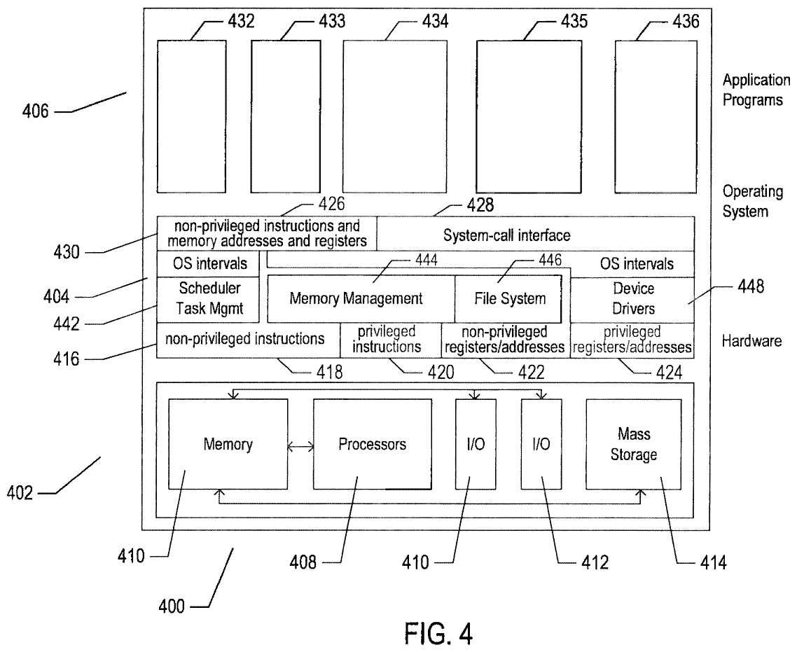

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402: (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different ty pes of operating systems. Operating systems continue to evolve, as a result of which certain older application programs and other computational entities may be incompatible with more recent versions of operating systems for which they are targeted, creating compatibility issues that are particularly difficult to manage in large distributed systems.

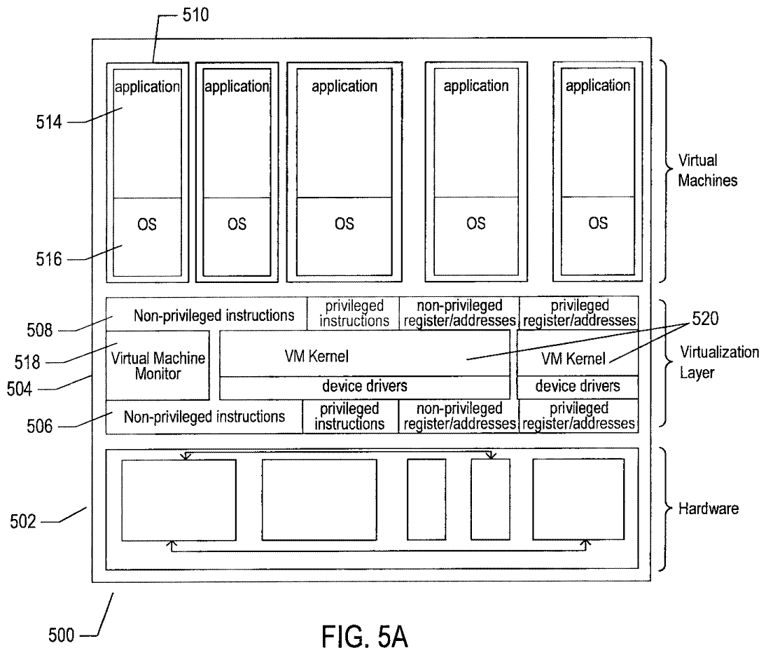

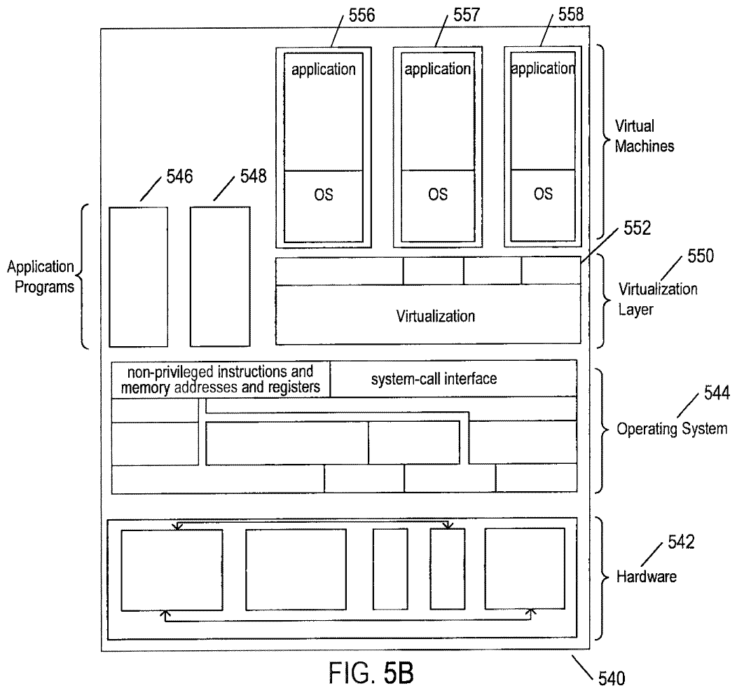

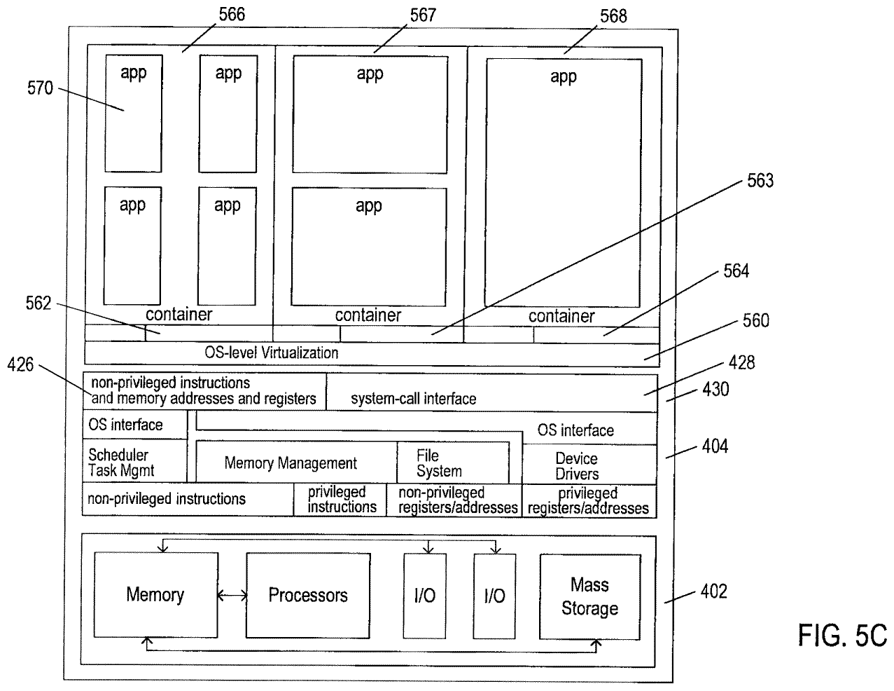

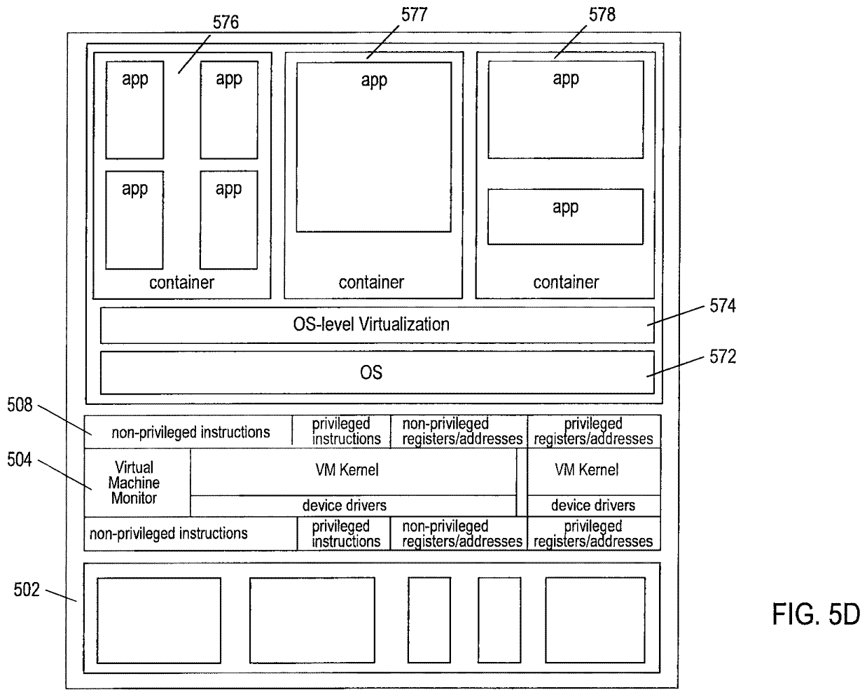

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

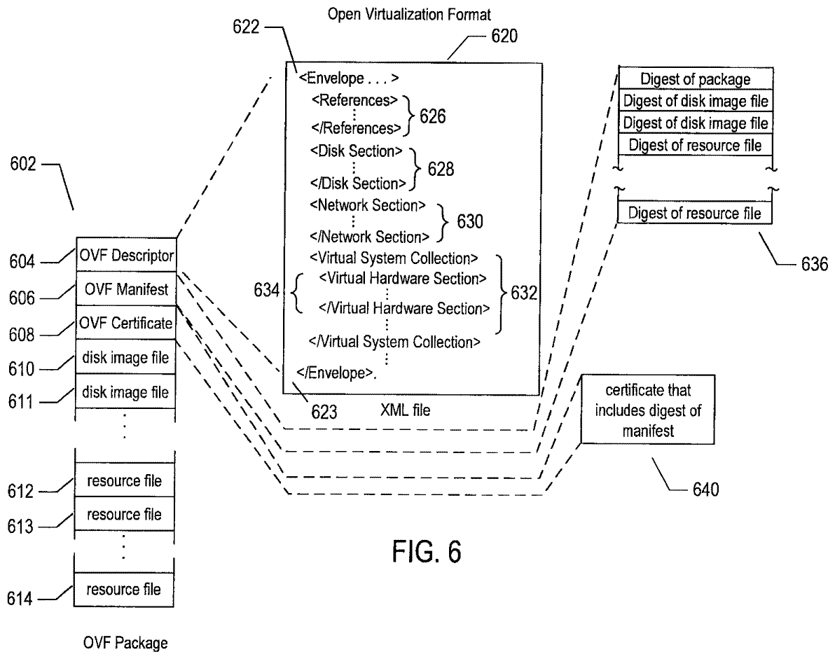

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

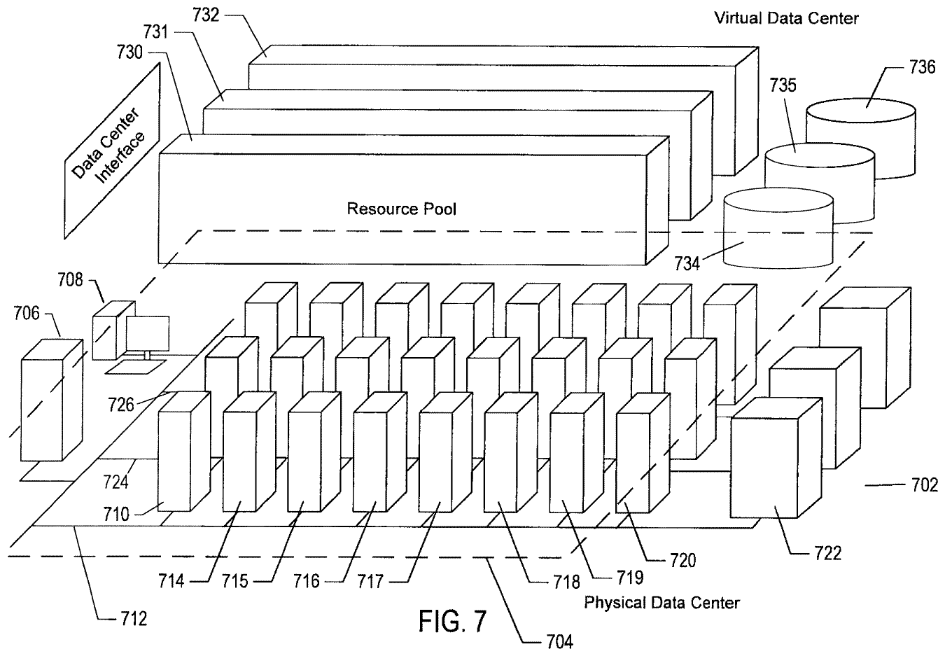

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

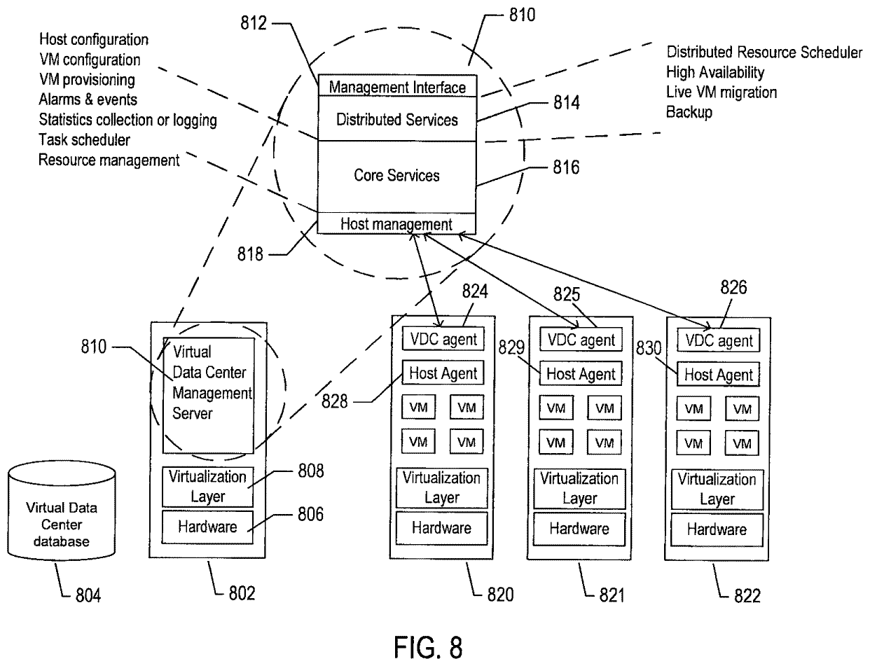

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

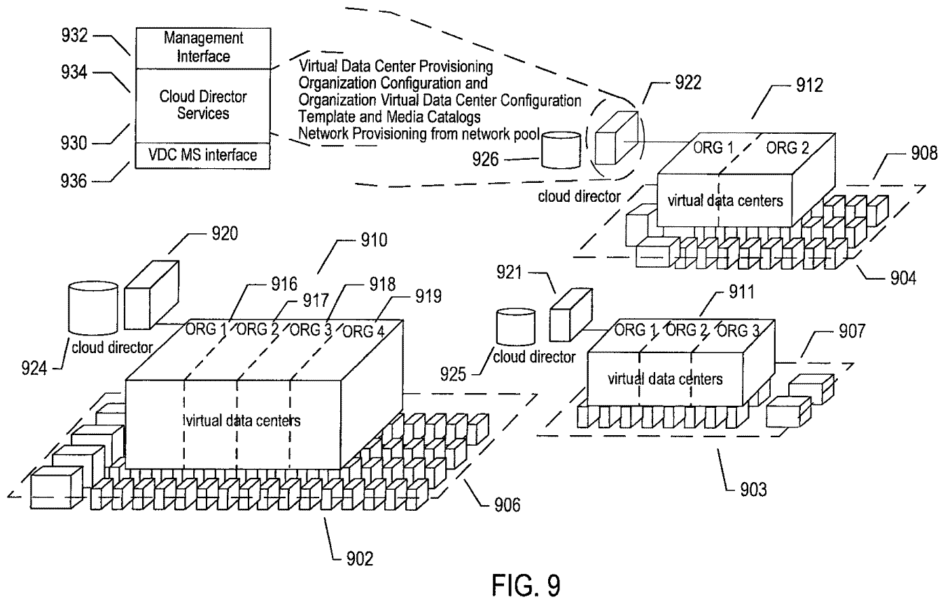

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

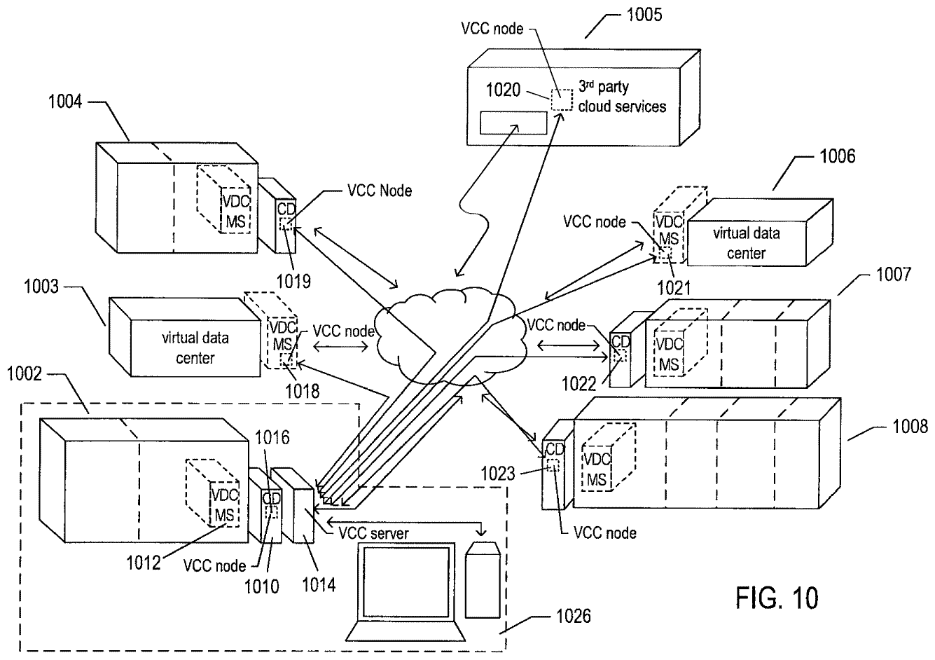

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC servers and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Kubernetes

Kubernetes is an automated, open-source containerized-application orchestration system that provides an abstraction layer above virtual and physical computational resources within a data center or cloud-computing facility. Containers are a type of virtualized application-execution environment discussed above with reference to FIGS. 5C-D. Containerized applications are applications that are packaged for execution within containers. Kubernetes automatically distributes and schedules containerized applications across physical and virtual computational resources of a data center or cloud-computing facility. As one example, modern service-oriented applications are generally implemented by distributed applications running on the multiple virtual machines or containers within multiple physical servers of a data center or cloud-computing facility. Rather than manually installing and managing all of these different virtual machines and/or containers, a user can develop Kubernetes workload-resource specifications and supply the workload-resource specifications along with references to containerized applications to a Kubernetes automated orchestration system, which instantiates and manages operation of the service-oriented application.

FIG. 11 illustrates a fundamental Kubernetes abstraction. A data center, cloud-computing facility, or other distributed computer system is represented, in FIG. 11, as a large number of physical computational resources, such as servers 1102. Kubernetes abstracts a portion of the physical and virtual computational resources provided by the underlying data center, cloud-computing facility, or other distributed computer system as a set of Kubernetes nodes 1104, where horizontal plane 1106 represents the fundamental Kubernetes abstraction of the underlying physical and virtual computational resources of the data center or cloud-computing facility. Kubernetes nodes may be virtual machines, physical computers, or other such computational entities that provide execution environments for containerized applications. The Kubernetes automated orchestration system is responsible for mapping Kubernetes nodes to the physical and virtual computational resources, including physical and virtual data-storage facilities and communications networks in addition to containerized-application execution environments.

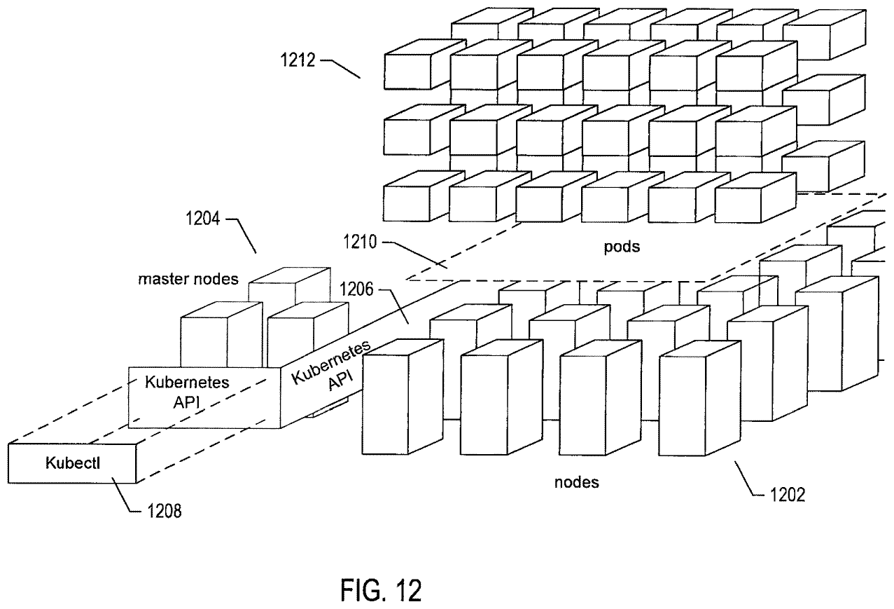

FIG. 12 illustrates a next level of abstraction provided by Kubernetes, referred to as a “Kubernetes cluster.” A Kubernetes cluster comprises a set of highly available, interconnected Kubernetes nodes that are managed by Kubernetes as a computational entity. The nodes in a cluster are partitioned into worker nodes 1202, often simply referred to as “nodes,” and master nodes 1204 that together implement a Kubernetes-cluster control plane. In general, only one of the master nodes is active at any given time, with the inactive master nodes providing for immediate failover in the case that the active master node fails. The control plane is responsible for distributing containerized applications among the worker nodes and scheduling execution of the containerized applications. In addition, the control plane manages operation of the nodes and containerized applications executing within the nodes. The control plane provides a Kubernetes application programming interface (“API”) 1206 through which the control plane communicates with the nodes and through which Kubernetes services and facilities are accessed by users, often via the Kubectl command line interface 1208. An additional Kubernetes layer of abstraction 1210 provides a set of pods 1212 that are deployed to, and that provide execution environments within, the nodes 1202. A pod is the smallest computational unit in Kubernetes. A pod supports execution of a single container or two or more tightly coupled containers, including shared data-storage and networking resources, that are scheduled and deployed together by the cluster control plane. In many cases, a pod includes only a single container that provides an execution environment for a single instance of a containerized application. Pods are created and managed by controllers for workload resources, discussed below, and are each associated with a pod template, or pod specification.

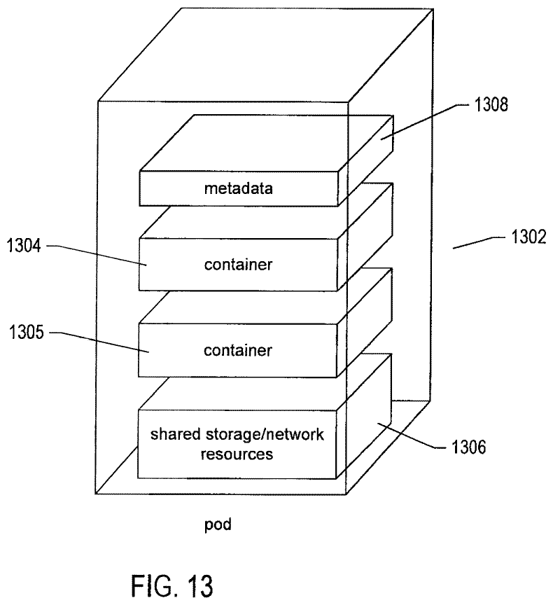

FIG. 13 illustrates the logical contents of a pod. The pod 1302 includes one or more containers 1304-1305, shared storage and networking resources 1306, and various types of metadata 1308, including operational parameters and resource requirements. A pod is assigned a set of unique network addresses that is shared, along with a set of ports, by all of the containers in the pod. Containers within a pod can communicate with one another via shared memory, semaphores, and localhost.

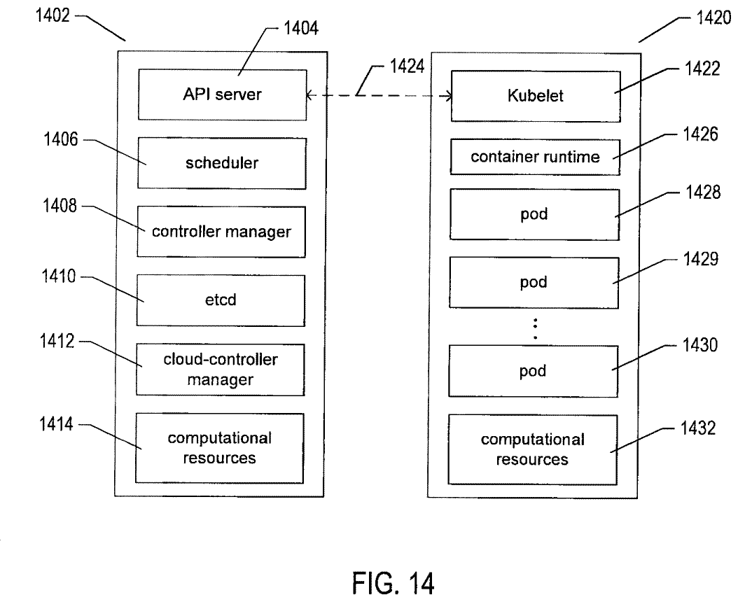

FIG. 14 illustrates the logical contents of a Kubernetes management node and a Kubernetes worker node. A Kubernetes management node 1402 includes an API server 1404 that exposes the Kubernetes API to remote entities and that implements the control-plane front-end. In addition, a Kubernetes management node includes a scheduler 1406 that is responsible for distributing newly created pods among worker nodes, matching pod requirements, constraints, affinities and parameters to the parameters and characteristics of the worker nodes to which a pod is distributed. A Kubernetes management node additionally includes a controller manager 1408 comprising multiple processes that implement multiple controllers, including a node controller, a replication controller, an endpoints controller, and a service-account-and-token controller. Controllers monitor the operational status of pods within the cluster and attempt to ameliorate any detected departures from the specified operational behaviors of the pods. For example, the node controller detects failed nodes and attempts to mitigate node failures. As another example, the replication controller monitors replication objects to ensure that the proper number of pods are running for each replication object. A Kubernetes management node further includes an etcd key-value data store 1410 and a cloud-controller manager 1412, which includes multiple controllers that manage cloud-hosted Kubernetes cluster components. The above-discussed logical components of a master node are implemented above the computational resources 1414 provided by a virtual machine or physical server. A worker node 1420 includes a Kubelet agent 1422 that manages pods running within the worker node in cooperation with the control plate, with which the Kubelet agent communicates via the Kubernetes API, as indicated by dashed arrow 1424. In addition, a worker node includes a container run time 1426, such as the Docker container runtime, and one or more pods 1428-1430 that execute using the computational resources 1432 provided by a virtual machine or physical server.

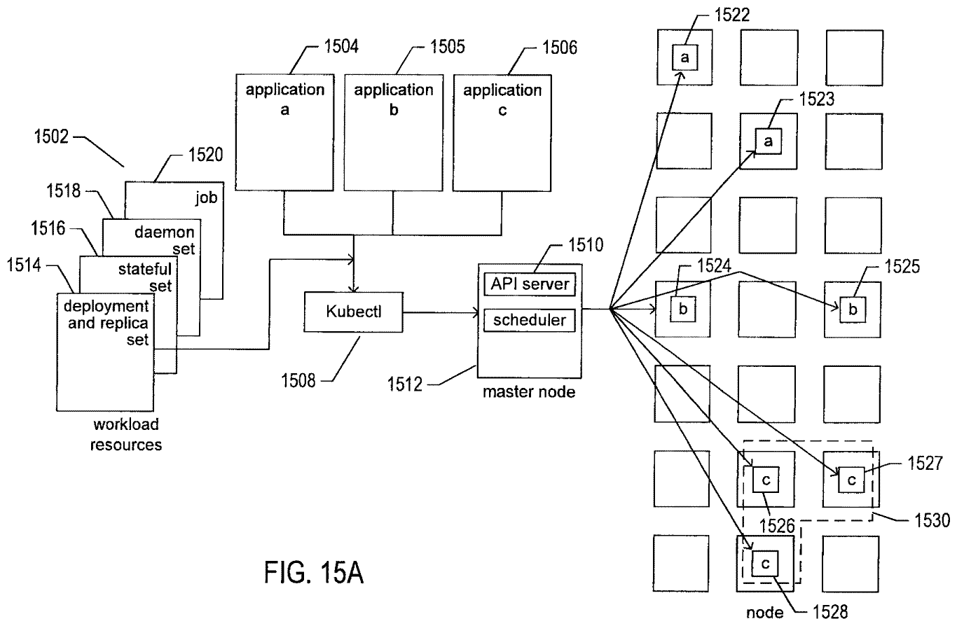

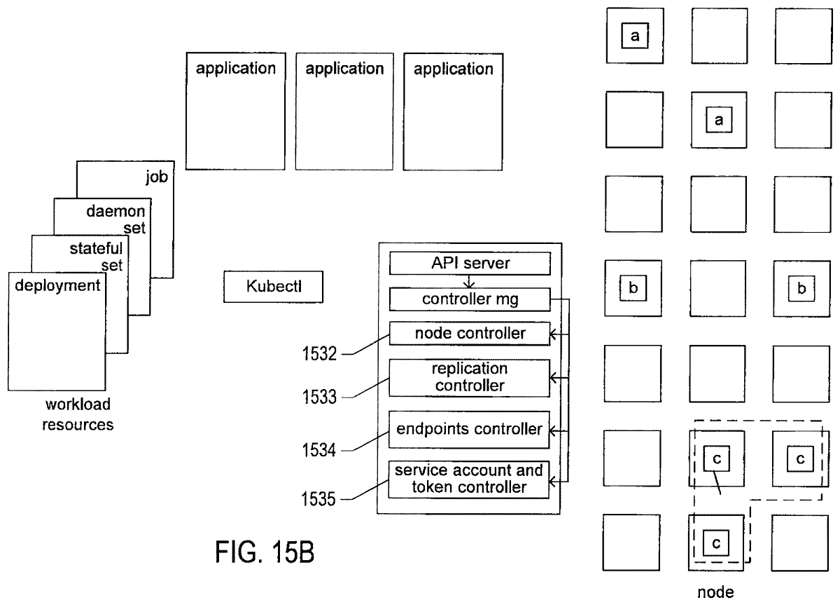

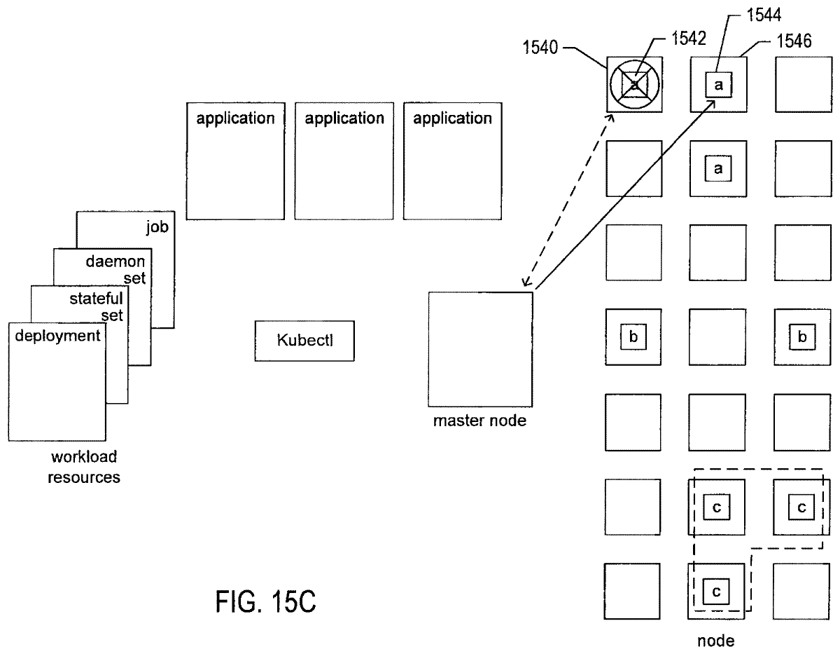

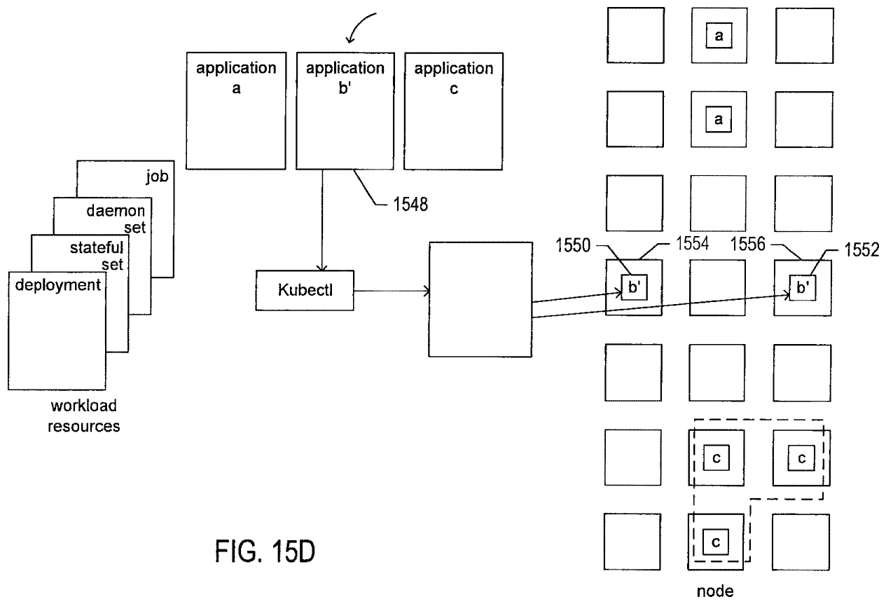

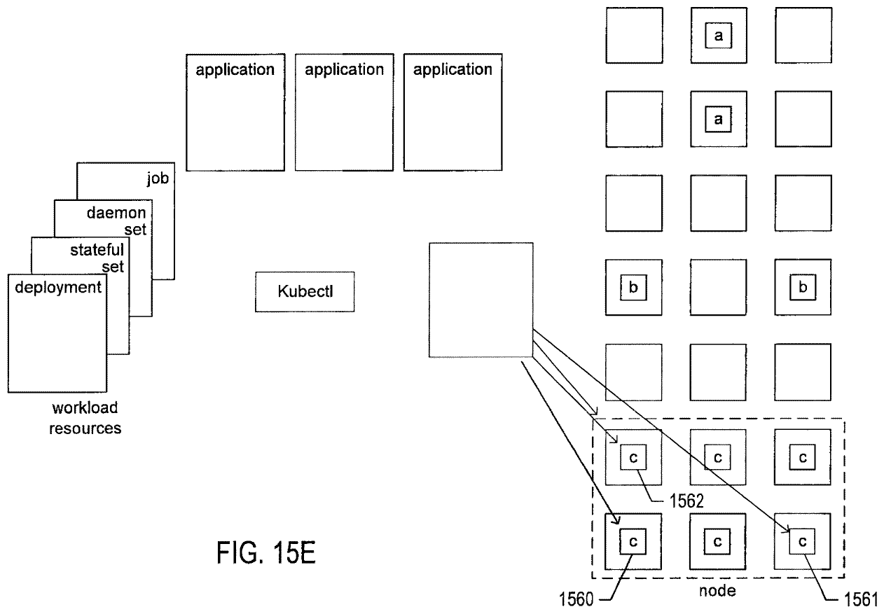

FIGS. 15A-E illustrate operation of a Kubernetes cluster. While there are many ways for a user to access a Kubernetes cluster and Kubernetes-cluster services through the Kubernetes API, a common approach to instantiating containerized applications is to develop a specification, referred to as a “configuration file,” that specifies one or more of various types of workload resources 1502 and to submit the configuration file, along with references to containerized applications 1504-1506, via the Kubectl command line interface 1508 to the Kubernetes API 1510 provided by a Kubernetes-cluster control plane 1512. The Kubernetes-cluster control plane distributes and schedules execution of a set of pods containing containerized-application instances of the containerized applications according to the workload-resource specification. The Kubernetes-cluster control plane then monitors the operational behaviors of the distributed pods over an execution lifetime specified in the workload-resource specification. Thus, the Kubernetes cluster automatically instantiates and manages executable instances of supplied containerized applications according to a workload-resource specification.

There are a number of different types of workload resources. A replicaSet workload resource 1514 is often used for instantiating and managing stateless applications. The Kubernetes control plane manages this type of workload resource, in part, by ensuring that a specified number of pods remain operational for each different type of containerized-application instance specified in the deployment. A statefulSet workload resource 1516 can be used to specify instantiation and management of a set of related pods associated with states. Additional types of workload resources include daemonSets 1518 and jobs 1520. In addition, Kubernetes supports specifying a service abstraction layer that includes a logical set of pods that are exposed to external communications and provided with service-related functionalities, including load-balancing and service discovery.

When, in the example shown in FIGS. 15A-F, the configuration file is input to a Kubernetes system via the Kubectl command line interface 1508, the active master node of the control plane invokes the scheduler to create and distribute pods containing the specified number of containerized-application instances among worker nodes of the cluster as well as to provide additional facilities for sets of pods defined to compose a service. In the example shown in FIG. 15A, two pods containing instances of application a 1522-1523, two pods containing instances of application b 1524-1525, and three pods containing instances of application c 1526-1528, which together compose a service, as indicated by dashed contour 1530, are created according to the input configuration file. As shown in FIG. 158, the Kubernetes control plate then invokes the controller manager to launch controllers 1532-1535 to monitor operation of the distributed pods which, in turn, launch execution of the containerized applications within the pods according to specifications contained in the configuration file.

FIGS. 15C-E illustrate various types of management operations carried out by the Kubernetes control plate during the lifetime of the workload resources instantiated in FIGS. 15A-B. As shown in FIG. 15C, when a node 1540 that originally hosted an instance of application a fails, as indicated by the “X” symbol 1542, a controller within the Kubernetes control plane detects the failure, after which the Kubernetes control plane creates a new pod to execute an instance of application a 1544 and distributes the new pod to a different, functioning node 1546. As shown in FIG. 15D, when a user supplies a reference to a new version of application b 1548 to the Kubernetes control plane via the Kubectl command line interface 1508, the Kubernetes control plate arranges for two replacement pods 1550 and 1552 containing instances of the new version of application b to be distributed to nodes 1554 and 1556, following which the original pods containing the older version of application b are terminated. As shown in FIG. 15E, when the Kubernetes control plane determines that the current workload associated with the service comprising three pods containing instances of application c (1530 in FIG. 15A) has increased above a specified threshold workload, the Kubernetes control plane automatically scales up this service to include three new pods 1560-1562 to which portions of the excessively high workload can be distributed. Detecting and ameliorating node failures, carrying out updates and upgrades of executing containerized applications, and automatically scaling up and scaling down a deployed workload resource are examples of the many different types of management services and operations provided by a Kubernetes cluster via a set of controllers running within the active management node. Controllers monitor pod operations for occurrences of various types of events and invoke event handlers to handle the events, with each different type of controller monitoring and handling different types of events. The control plane thus dynamically controls the worker nodes in accordance with the configuration file or files that define the configuration and operational behaviors of each workload resource.

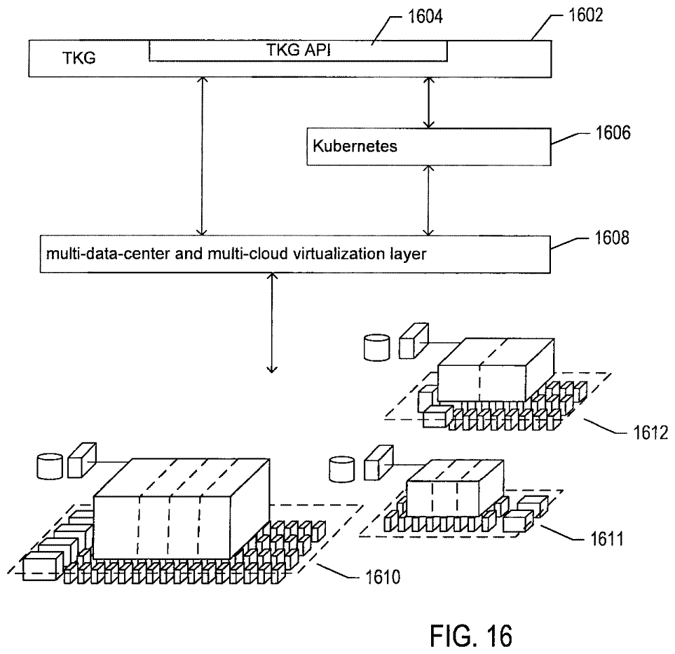

FIG. 16 illustrates the Tanzu Kubernetes Grid (“TKG”) containerized-application automated orchestration system. TKG is a higher-level automated orchestration system that automatically instantiates and manages Kubernetes clusters across multiple data centers and clouds. TKG 1602 provides, through a TKG API 1604, similar services and functionality to those provided by Kubernetes. In fact, TKG is layered on top of Kubernetes 1606. However, TKG is also layered above the multi-data-center and multi-cloud virtualization layer 1608, such as the multi-cloud aggregation distributed system discussed above with reference to FIG. 10. This allows TKG to support Kubernetes-like clusters across multiple data centers and cloud-computing facilities 1610-1612. This also allows TKG to migrate nodes among different data centers and cloud-computing facilities and provide additional functionalities that are possible because of TKG's access to services and functionalities provided by the multi-data-center and multi-cloud virtualization layer. In essence, TKG is a meta-level Kubernetes system. Like Kubernetes, TKG uses both a control plane comprising specialized control-plane nodes as well as a set of worker Kubernetes clusters across which TKG distributes workload resources.

### Currently Disclosed Methods and Systems

FIG. 17 illustrates a distributed-computing environment in which one implementation of the currently disclosed methods and systems is used to facilitate metrics collection. Multiple client Kubernetes clusters, including Kubernetes clusters 1702-1704, are at least partially managed by global-controller-and-observer functionality in a management Tanzu cluster 1706 that provides the client Kubernetes clusters with a Tanzu Service Mesh. The Tanzu Service Mesh provides control, security, visibility, and autoscaling functionalities to the customers/clients of the Tanzu Service Mesh. To facilitate service provision, the global controller-and-observer functionality in the management Tanzu cluster collects massive amounts of metric data from the pods within the client Kubernetes clusters, as represented by arrows, such as arrow 1708, in FIG. 17. For example, a customer Kubernetes cluster might have 30,000 Kubernetes pods that generate service-call-and-response traffic among themselves at a rate of many thousands of service requests per second. Each service request, in turn, may generate one or more metrics that are forwarded to the global controller-and-observer functionality in the management Tanzu cluster.

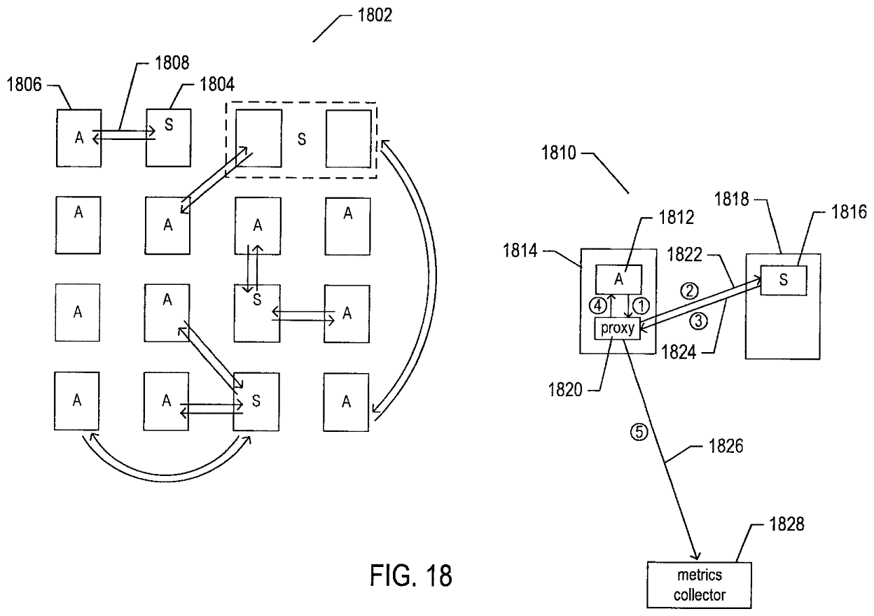

FIG. 18 illustrates one process by which metric messages are sent from client Kubernetes cluster pods to the global controller-and-observer functionality in the management Tanzu cluster. A number of client Kubernetes cluster pods 1802 are shown in a two-dimensional matrix on the left-hand side of FIG. 18. Certain of the pods, such as pod 1804, are labeled “S.” indicating that they support execution of a service and other of the pods, such as pod 1806, are labeled “A,” indicating that they support execution of an application. Applications make service calls to services and receive responses to those service calls from services, as represented by pairs of arrows, such as the arrow pair 1808 representing a service call from the application executing in pod 1806 to the service provided by pod 1804.

Each service call response generates a metric message that is sent to the global controller-and-observer functionality in the management Tanzu cluster. One approach for sending metric messages is illustrated on the right-hand side 1810 of FIG. 18. An application 1812 within a client Kubernetes cluster pod 1814 makes a call to a service 1816 running within another client Kubernetes cluster pod 1818 by calling a service proxy 1820 running within pod 1814. The service proxy then forwards the service call 1822 to the service 1816, which returns a response to the call 1824. The proxy then forwards the response to the application and transmits a metric message 1826 to a metrics collector 1828 within the global controller-and-observer functionality in the management Tanzu cluster. Thus, service proxies running within client Kubernetes cluster pods serve as intermediaries for service calls within the client Kubernetes cluster that automatically generate and send a metric message for each service call to the metrics collector 1828 within the global controller-and-observer functionality in the management Tanzu cluster.

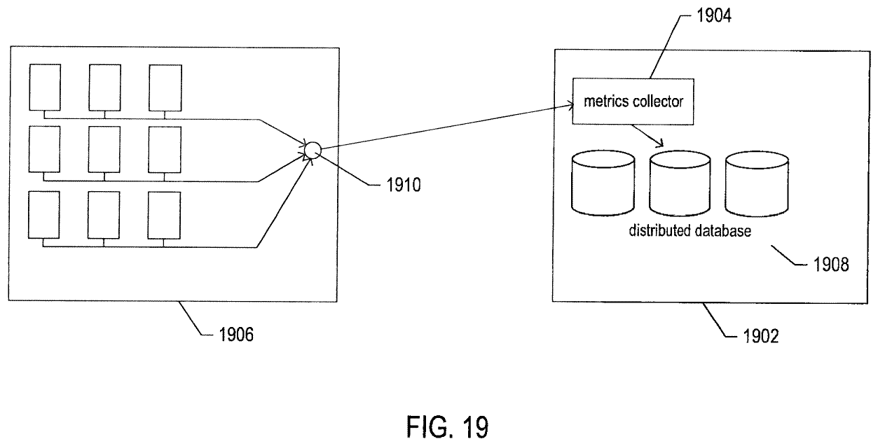

FIG. 19 illustrates the architecture for metrics generation and collection in a first metrics-generation-and-collection implementation of the distributed-computing environment discussed above with reference to FIGS. 17-18. The global controller-and-observer functionality 1902 within the management Tanzu cluster includes a metrics collector 1904 that receives metrics messages from clients Kubernetes clusters, such as client Kubernetes cluster 1906, and stores the metrics extracted from the received metrics messages in a distributed database 1908 within the management Tanzu cluster. The server proxy within each pod of the client Kubernetes cluster forwards metric messages through local networks to a communications edge 1910 from which they are transmitted through a wide-area network to the metrics collector 1904. The metrics collector may be implemented as a multi-threaded application or service within the management Tanzu cluster. The received metrics messages are subsequently accessed for a variety of different analytical, monitoring, and management tasks and operations carried out by the global controller-and-observer functionality in the management Tanzu cluster.

However, there are many disadvantages associated with the architecture illustrated in FIG. 19. Because there may be many different client Kubernetes clusters at least partially managed by the global controller-and-observer functionality in the management Tanzu cluster, the volume of metrics messages may be extremely large, as a result of which execution of the metrics collector the management Tanzu cluster may represent a significant computational and networking overhead. As additional client Kubernetes clusters are added to the Tanzu Service Mesh, the computational and networking overheads correspondingly increase, representing a significant scale-up problem for the management Tanzu cluster, including the need for upscaling the metrics collector as well as potentially upscaling the distributed database. Furthermore, the customers/clients using the Tanzu Service Mesh may pay very large networking fees for the high volume of metrics messages transmitted from client Kubernetes clusters to the management Tanzu cluster.

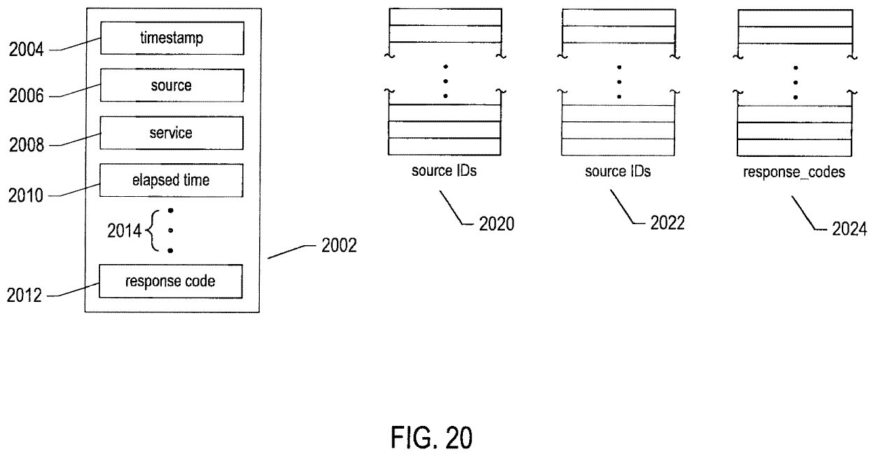

FIG. 20 illustrates a typical metrics message. The metrics message 2002 is a formatted data payload within a network message, and typically includes a timestamp 2004, an indication of a workload source, or application, 2006 that made a service call within a client Kubernetes cluster, an indication of the service 2008 to which the service call was made, an indication of the elapsed time 2010 between the service call and reception of a response to the service call, and a response code 2012, such as an indication of success or failure. Ellipsis 2014 indicates that a particular type of metrics message may include additional fields containing additional values. The values may be numeric values, character strings, character strings containing formatted date/time representations, and other values. The source field 2006 may, in certain implementations, contain a numeric or alphanumeric source ID selected from a set 2020 of possible source IDs for a particular client Kubernetes cluster. Similarly, the service field 2008 may contain a numeric or alphanumeric service ID selected from a set 2022 of possible service IDs for a particular client Kubernetes cluster. The response-code field 2012 may contain a numeric response code selected from a set 2024 of possible response codes.

As discussed above, the metrics collector may handle large volumes of metrics messages received from pods within many different client Kubernetes clusters, and these large volumes of metrics messages may be associated with large costs and computational, networking, and data-storage overheads. Quite often, the metrics collected by the metrics collector and stored in the distributed database are subsequently used to compute aggregate metrics and trends to facilitate management, monitoring, and analysis tasks carried out by the management Tanzu cluster. One approach to alleviating certain of the overheads and costs associated with collected metrics messages is for the metrics collector to generate aggregated metrics from the received metrics messages and to then store the aggregated metrics into the distributed database.

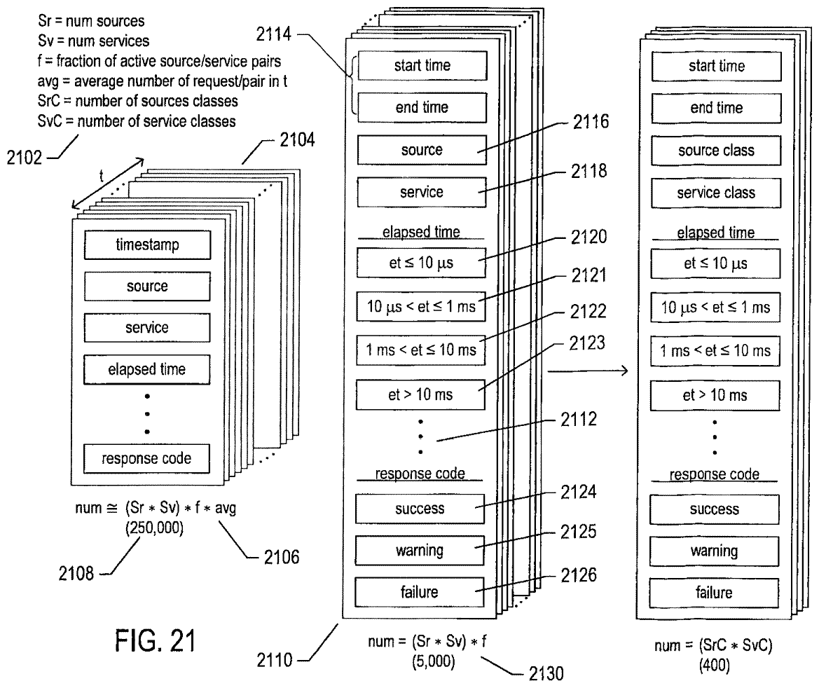

FIG. 21 illustrates generation of aggregate metrics from received metric messages. In the top left-hand corner 2102 of FIG. 21, a number of constants used in FIG. 21 are introduced: (1) Sr, the number of sources in a client Kubernetes cluster, (2) Sv, the number of services in a client Kubernetes cluster: (3) f, the fraction of source/service pairs that are currently active or, in other words, exchanging service requests and responses; (4) avg, the average number of service requests per active source/service pairs during a time interval t; (5) SrC, a number of source or source ID classes; and (6) SvC, a number of service or service ID classes. In an example computing environment, such as that discussed above with reference to FIGS. 17-20, an estimate of the number of metrics messages 2104 sent from a client Kubernetes cluster to the metrics collector during a time interval t is equal to the product 2106 of the four constants Sr, Sv, f, and avg. In the case that Sr=100, Sv=100, f=0.5, and avg=50, an estimate for the number of metrics messages is computed as 250,000 (2108 in FIG. 21). In a first approach to aggregating the data in the received metrics messages 2104, a single aggregate metrics message for each source/service pair can be generated to produce a set of aggregate metrics messages 2110. In one example of this approach, all of the received metrics messages for a particular source/service pair are used to generate counts of quantized elapsed times and response-code classes for the received metrics messages for the source/service pair. A particular aggregate metrics message 2112 for a particular source/service pair includes: (1) a start-timestamp/end-timestamp pair 2114 indicating the earliest and latest timestamps in the set of received metrics messages for the source/service pair; (2) a source field 2116 containing the source ID for the source/service pair; (3) a service field 2118 containing the service ID for the source/service pair: (4) four quantized-elapsed-time-value fields 2120-2123 that contain indications of the number of received metrics messages with elapsed times within the ranges represented by the four quantized elapsed-time values; and (5) three response-code-class fields 2124-2126 that contain indications of the number of received metrics messages with response codes in each of the three response-code classes “success,” “warning,” and “failure.” Thus, the aggregated metrics message 2112 represents an aggregate result corresponding to all of the metrics messages received for a particular source/service pair during the time interval t. There are, of course, many different approaches to aggregating the data contained in multiple metrics messages, with the approach represented by aggregate metrics message 2112 representing one particular example. When the received metrics messages are transformed into the set of aggregated metrics messages 2110, the total number of aggregated metrics messages can be estimated as the product 2130 of the three constants Sr, Sv, f, and is equal to 5000 in the current numeric example, which is only 2% of the number of received metrics messages, 250,000. This represents a large reduction in the volume of data that needs to be stored, by the metrics collector, in the distributed database. An even greater reduction in the stored data can be obtained if the source IDs and service IDs are aggregated into source and service classes, in the same way that the response codes were aggregated into three response-code classes. In this case, in the event that there are only 20 source ID classes and 20 service ID classes, the total number of aggregated metrics messages is reduced to 400, which is only 0.16% of the number of received metrics messages.

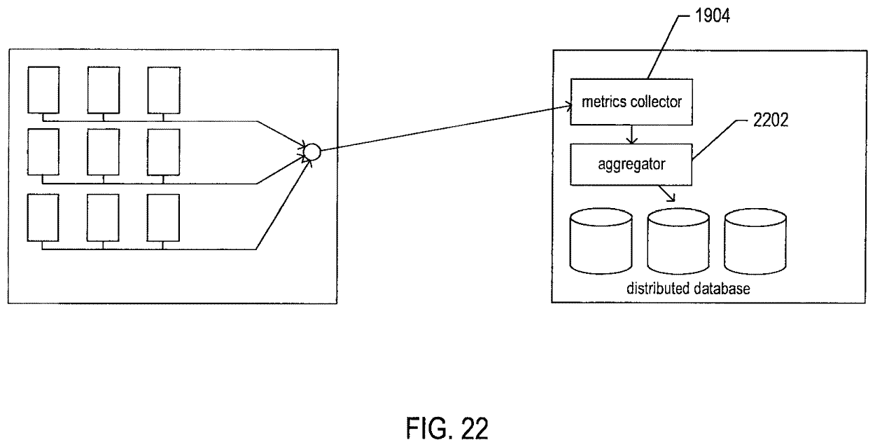

FIG. 22 illustrates an improved architecture for metrics generation and collection using the illustration conventions of FIG. 19. In the improved architecture, the metrics collector 1904 forwards received metrics messages to an aggregator 2202. The aggregator, for each of multiple time periods, aggregates the received metrics messages into one or more aggregated metrics messages, as discussed above with reference to FIG. 21, and forwards the one or more aggregated metrics messages to the distributed database for storage. This improved architecture addresses the problematic data-storage overheads associated with the first architecture for metrics generation and collection shown in FIG. 19. However, the computational and networking overheads and the scaling issues discussed above with reference to FIG. 19 are not necessarily addressed by the improved architecture.

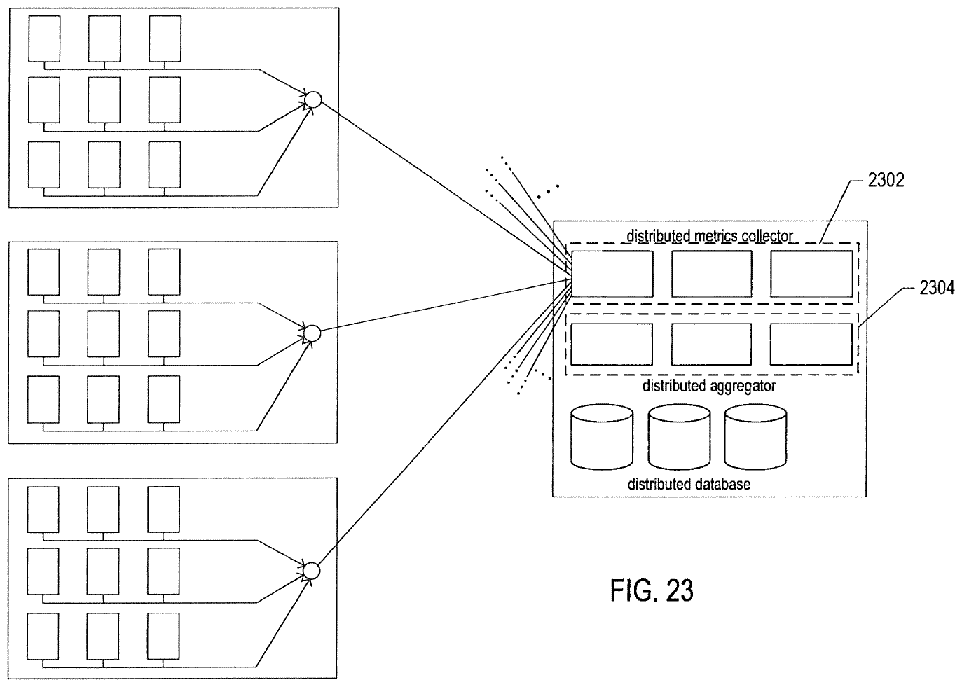

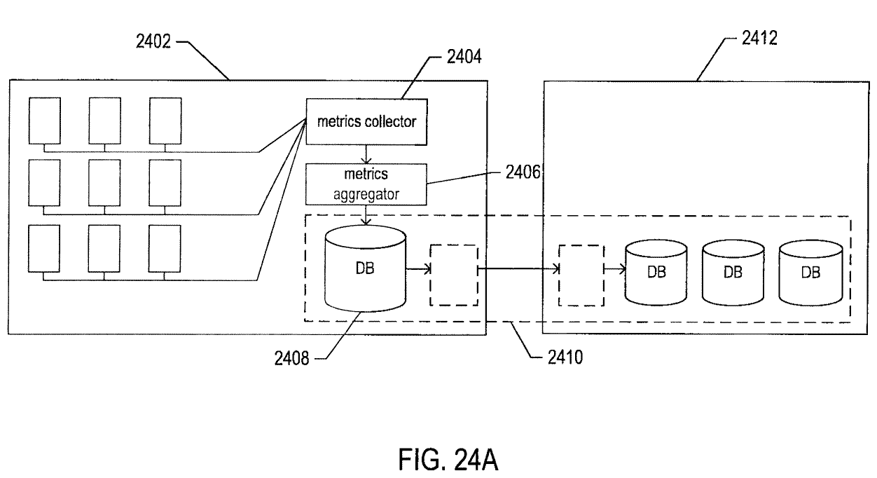

FIG. 23 illustrates a further-improved architecture for metrics generation and collection. In this approach, both the metrics collector and the aggregator are implemented as distributed applications or services. The distributed metrics collector 2302 and the distributed aggregator 2304 may address the scaling issues discussed above with reference to FIG. 19, but fail to address the computational and networking overheads. As the number of client Kubernetes clusters increases, the total networking costs borne by the clients increases linearly and the computational and networking overheads for the management Tanzu cluster may increase even faster, due to overheads associated with distributing the metrics collector and aggregator.

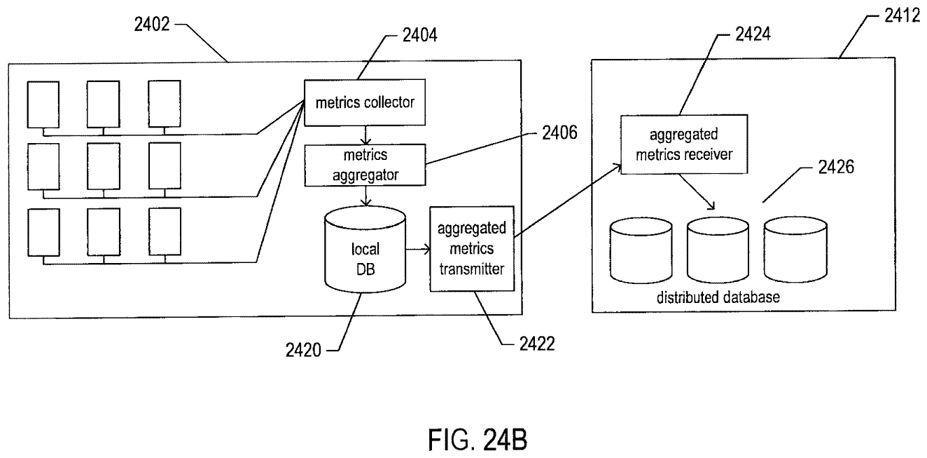

FIGS. 24A-B illustrates a still-further-improved architecture for metrics generation and collection. In the approach shown in FIG. 24A, the metrics collector and metrics aggregator have been decentralized, with each client Kubernetes cluster, such as client Kubernetes cluster 2402, including a local metrics collector 2404, local metrics aggregator 2406, and a local component database 2408 of a distributed database 2410 that spans the client Kubernetes clusters as well as the management Tanzu cluster 2412. This still-further-improved architecture addresses the above-discussed computational and networking overheads, the scaling problems, and the networking-costs problems. The metrics messages generated within the client Kubernetes cluster are not individually transmitted to the management Tanzu cluster, greatly reducing networking costs to clients. The scaling issues are addressed, since each client Kubernetes cluster added to the Tanzu Service Mesh includes a local metrics collector and metrics aggregator. The computational overhead for metrics collection and aggregation is distributed across the client Kubernetes clusters. However, the architecture shown in FIG. 24A does suffer a new problem with respect to the distributed database. A requirement for adding a complex component, such as a local instance of a distributed database, to client Kubernetes clusters in order to facilitate metrics collection would represent a new set of licensing and management issues that would likely outweigh the advantages of using a distributed database spanning both the management Tanzu cluster and the client Kubernetes clusters. For this reason, the final architecture shown in FIG. 24B provides an optimal or near optimal solution to the above-discussed problems in many cases. In this final architecture, the local metrics collector 2404 and metrics aggregator 2406 produce aggregated metrics messages that are temporarily stored in a local database 2420 within a client Kubernetes cluster. An aggregated metrics transmitter 2422, also included within the client Kubernetes cluster, periodically transfers batches of aggregated metrics messages to an aggregated metrics receiver 2424 within the management Tanzu cluster 2412. The aggregated metrics receiver then stores the aggregated metrics messages into the distributed database 2426 within the management Tanzu cluster.

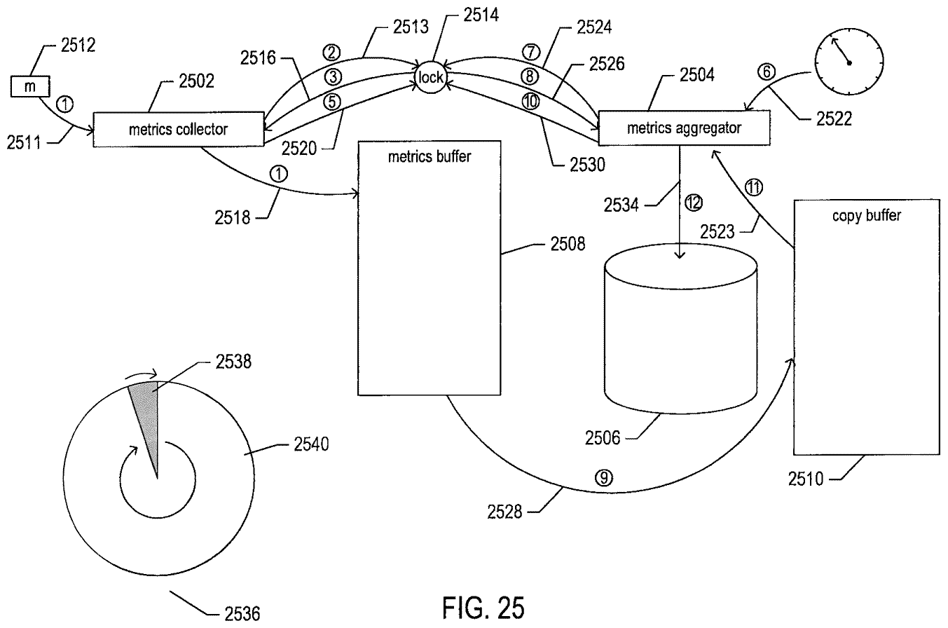

FIG. 25 illustrates additional details with respect to the final architecture for metrics generation and collection discussed above with reference to FIG. 24B. The local metrics collector 2502, local metrics aggregator 2504, and the local metrics database 2506 within a client Kubernetes cluster are again shown in FIG. 25. FIG. 25 additionally shows a metrics buffer 2508, in which the metrics collector stores received metrics messages, and a copy buffer 2510, into which the metrics aggregator periodically copies metrics messages from the metrics buffer. The metrics collector 2502 receives 2511 a metrics message 2512 from the service proxy within a part of the client Kubernetes cluster. The metrics collector then requests 2513 exclusive, temporary possession of a lock 2514, which controls access to the metrics buffer 2508. When the lock request is granted 2516, the metrics collector stores 2518 the received metrics message 2512 in the metrics buffer 2508 and then requests release 2520 of the lock 2514. The metrics collector periodically acquires the lock 2514 in order to append each received metrics message to the metrics buffer. At periodic intervals, indicated to the metrics aggregator by a timer 2522, the metrics aggregator requests 2524 exclusive, temporary possession of the lock and, when the lock request is granted 2526, copies metrics messages 2528 from the metrics buffer to the copy buffer. Then, the metrics aggregator releases the lock 2530 and processes the copied metrics messages 2532 to generate aggregated metrics messages that are then stored 2534 into the local database 2506 for eventual migration to the management Tanzu cluster. As indicated by pie chart 2536, during each time interval represented by the outer circumference of the pie chart, the metrics aggregator holds the lock in order to copy metrics messages from the metrics buffer to the copy buffer for only a relatively short time 2538 compared to the much larger portion of the time interval 2540 during which the metrics collector holds the lock in order to append messages to the metrics buffer.

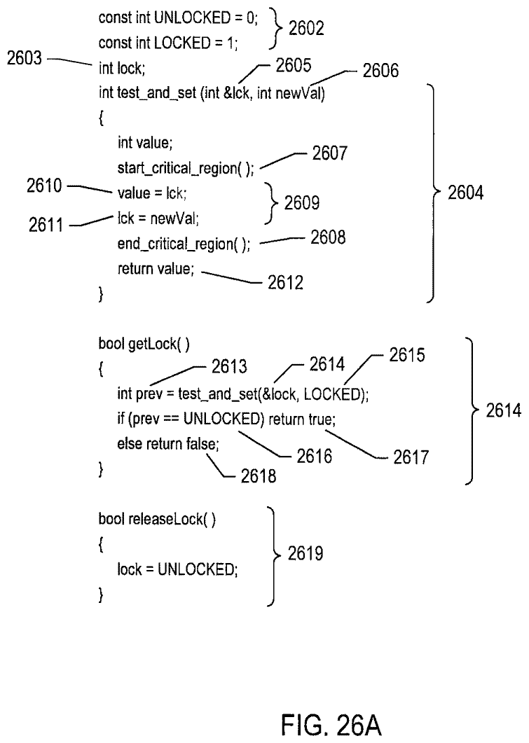

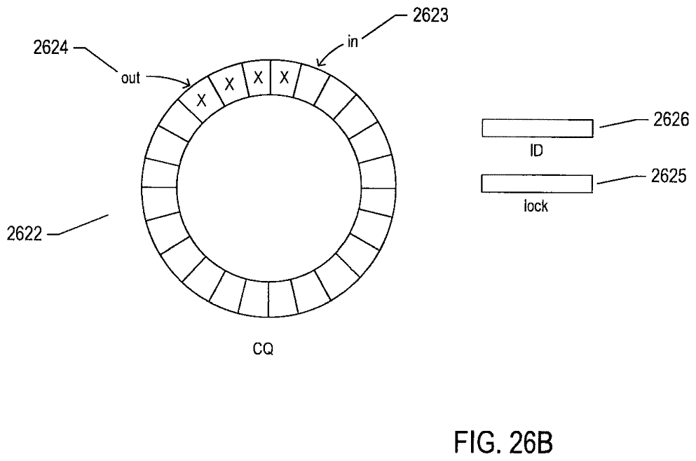

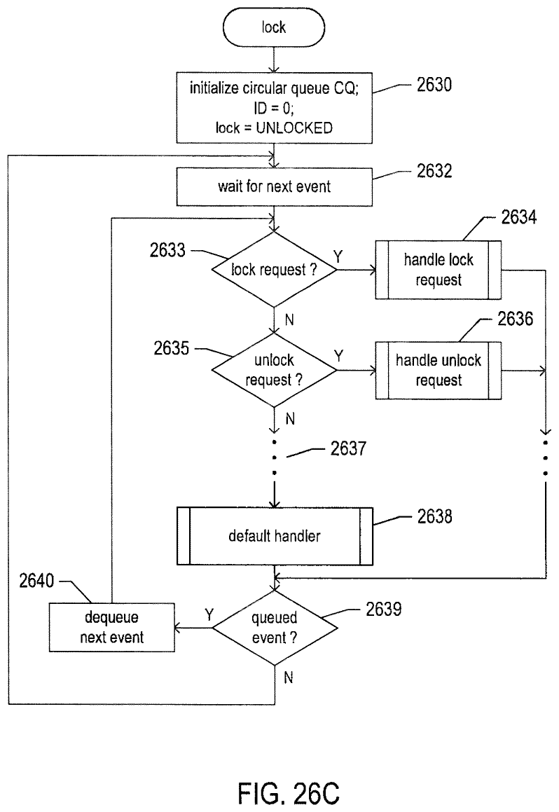

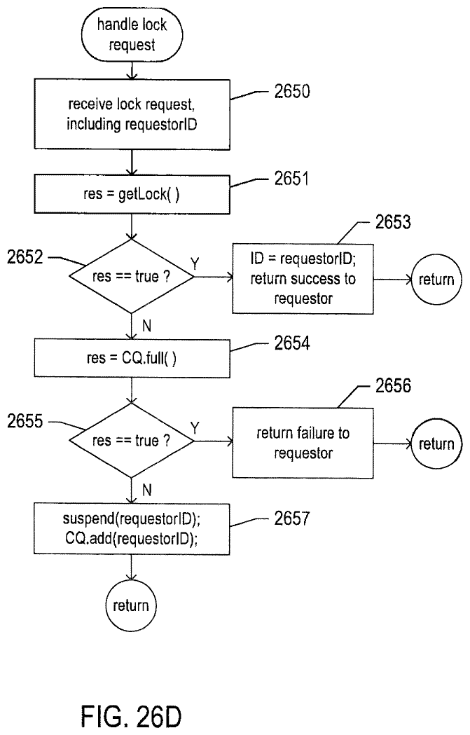

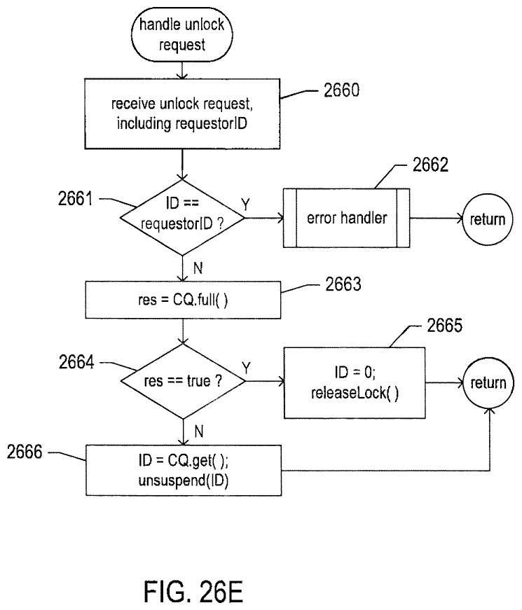

FIGS. 26A-E illustrate one implementation of the lock 2514 shown in FIG. 25. FIG. 26A provides pseudocode for a basic lock implemented using a test-and-set instruction. Two constants LOCKED and UNLOCKED are first declared in the initial lines 2602 of the pseudocode shown in FIG. 26A. An integer lock 2603 is then declared. The routine test_and_set 2604 receives, as arguments, a reference to an integer lck 2605 and a new integer value newVal 2606 to be stored in the lock referenced by the argument lck. The two function calls 2607 and 2608 represent a bracketed critical region 2609. Many computer architectures support a test-and-set instruction that carries out the two instructions of the critical region in a non-interruptible fashion. Thus, the two function calls 2607 and 2608 along with the two instructions of the critical region 2609 would be implemented by a single test-and-set instruction for execution on computers of these computer architectures. The first instruction 2610 of the critical region sets a local variable value to the current value of the referenced lock and the referenced lock is then set by the second instruction 2611 of the critical region to the new value received as the second argument 2606. The routine test-and-set then returns the value read from the lock 2612. The routine getLock 2614 is called to acquire the lock. A local variable prev 2613 receives the value returned by the routine test_and_set called with a reference 2614 to the lock 2603 and with the new value LOCKED 2615. If the current value of the local variable prev, following the call to the routine test_and_set, is UNLOCKED 2616, the routine getLock returns the value true 2617, indicating that the caller of the routine getLock has acquired the lock. Otherwise, the routine getLock returns the value false 2618, indicating that the caller of the routine getLock has failed to acquire the lock. The routine releaseLock 2619 sets the lock to the value UNLOCKED, releasing the lock.

FIG. 26B illustrates a data structure and variables used in control-flow diagrams provided in FIGS. 26C-E, which illustrate implementation of the lock 2514 discussed above with reference to FIG. 25. The data structure is a circular queue 2622 CQ which stores process or thread IDs. A circular queue includes a first pointer 2623 to an empty slot into which to next queue and ID and a second pointer 2624 that references a next ID to dequeue from the circular queue. The circular queue implements a first-in-first-out queue. Circular queues are implemented using modular pointer arithmetic to transform a linear memory buffer into a circular queue. The integer variable lock 2625 is used as a lock that can be acquired and released by the getLock and releaseLock routines discussed above with reference to FIG. 26A. The variable ID 2626 stores the process or thread ID of a current lock holder.

FIG. 26C provides a control-flow diagram for the lock 2514 shown in FIG. 25. The lock is similar to a semaphore implemented above a test-and-set lock. The lock provides for automatic suspension of threads or processes waiting to acquire the lock. One reason for using a semaphore-like lock is that the message collector may be multi-threaded or distributed across multiple processes. In step 2630, the lock initializes circular queue CQ, sets the variable ID to 0, and sets the variable lock to UNLOCKED. It is assumed that no process or thread ID has the value 0 in the current lock implementation. Then, in step 2632, the lock waits for a next event. When the next event is a lock request, as determined in step 2633, a routine “handle lock request” is called, in step 2634. When the next event is an unlock request, as determined in step 2635, a routine “handle unlock request” is called in step 2636. Ellipsis 2637 indicates that additional types of events may be handled. For example, various timer expirations may be handled for various types of error-detection and error-correction logic, such as detection of a failure of a process or thread currently holding the lock to release it, perhaps due to the thread or process having crashed. A default handler is called, in step 2638 to handle any rare and unexpected events. Following handling of the most recent event, the lock determines whether any additional events have been queued for handling, in step 2639. If so, a next event is dequeued, in step 2640, and control returns to step 2633 to handle the dequeued event. Otherwise, control returns to step 2632, where the lock waits for the occurrence of a next event.

FIG. 26D provides a control-flow diagram for the routine “handle lock request,” called in step 2634 of FIG. 26C. In step 2650, the routine “handle lock request” receives a lock request, including the thread or process ID of the requesting thread or process, referred to as the “requestor ID.” In step 2651, the routine “handle lock request” calls the routine getLock to attempt to acquire the lock represented by variable lock. When the routine getLock returns the value true, as determined in step 2652, the routine “handle lock request” sets the variable ID to the received requestor ID and returns a success indication to the requestor, in step 2653, before returning. Otherwise, in step 2654, a local variable res is set to the value returned from a call to the CQ member function full( ). This function call returns a Boolean value indicating whether or not the circular queue CQ is full. If so, as determined in step 2655, the routine “handle lock request” returns a failure indication to the requestor, in step 2656. Otherwise, in step 2657, the routine “handle lock request” suspends execution of the requestor and adds the requestor ID to the circular queue CQ. The requesting process or thread will therefore wait until the lock is acquired on its behalf, at which point it will resume executing.

FIG. 26E provides a control-flow diagram for the routine “handle unlock request,” called in step 2636 of FIG. 26C. In step 2616, the routine “handle unlock request” receives an unlock request including the requestor ID of the thread or process that issued the unlock request. When the value stored in local variable ID is equal to the received requestor ID, as determined in step 2661, an error handler is called, in step 2662, since only the lock holder should be attempting to release the lock. Otherwise, in step 2663, the local variable res is set to the value returned by the CQ member function empty( ). This member function returns a Boolean value indicating whether or not the circular queue CQ is empty. If so, as determined in step 2664, the local variable ID is set to 0 and the routine releaseLock is called to release the lock, in step 2665. Otherwise, in step 2666, a requestor ID is dequeued from the circular queue CQ and the thread or process corresponding to the dequeued ID is unsuspended, so that the thread or process resumes execution after having acquired the lock.

The implementation shown in FIG. 25 for the local metrics collector and local metrics aggregator within a client Kubernetes cluster suffers from significant computational overhead and temporal delays due to contention for lock 2514. In the case of a multi-threaded metrics collector or a metrics collector distributed across multiple processes, when the rate at which metrics messages are received from pods within the client Kubernetes cluster exceeds a threshold rate, many of the threads or processes will end up suspended, waiting to acquire the lock, and the large number of log-acquisition and lock-release cycles will represent a significant portion of the computational bandwidth available to the local metrics collector and metrics aggregator. As more threads or processes wait for the lock, the throughput of a multi-threaded or distributed metrics collector will substantially be decreased and the rate at which metric messages can be received and stored in the local database may decrease, rather than accelerate, as would be expected for a multi-threaded or distributed local metrics collector.

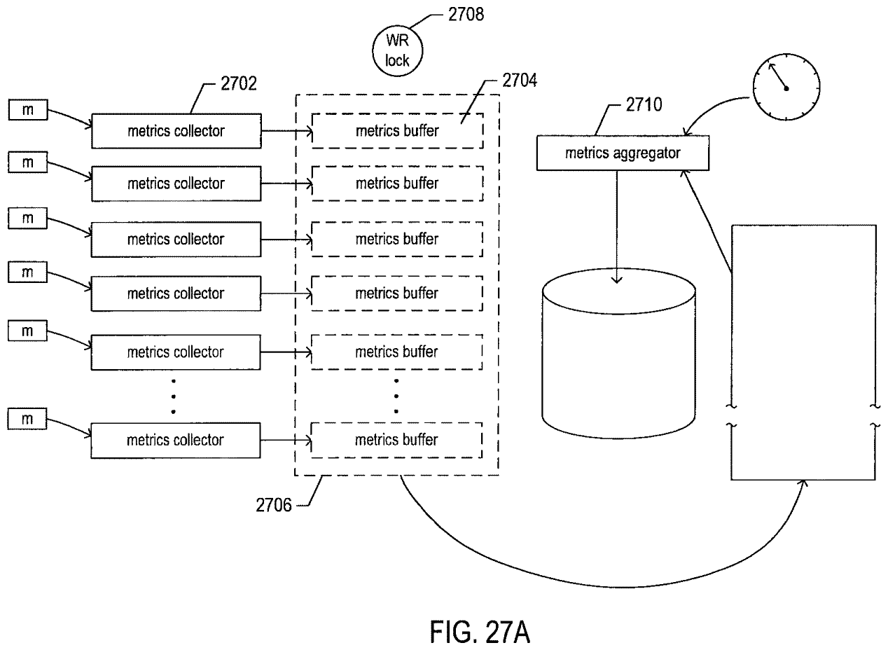

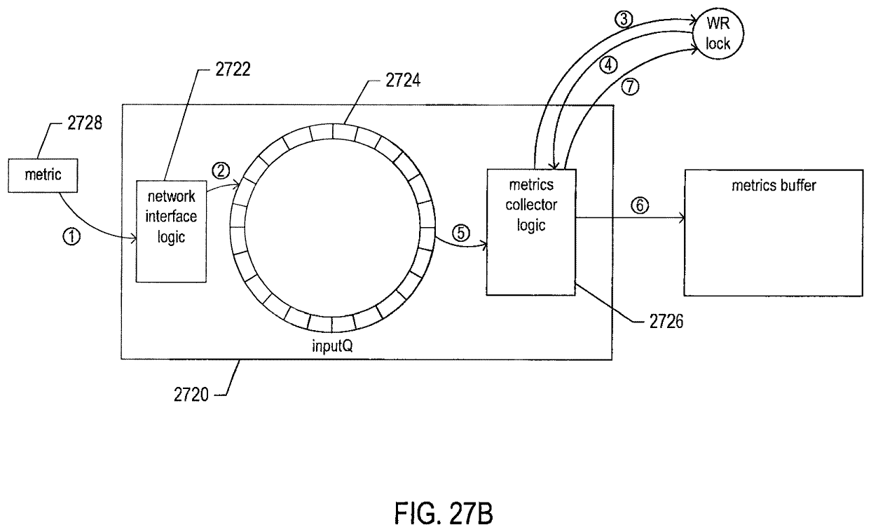

FIGS. 27A-B provide an improved implementation of the local metrics collector and metrics aggregator within a client Kubernetes cluster of a Tanzu Service Mesh. As shown in FIG. 27A, the metrics collector is multithreaded or distributed across multiple processes, and the metrics aggregator may also be multithreaded or distributed across multiple processes. Each metrics-collector thread or process, such as metrics-collector thread or process 2702, is associated with a metrics buffer, such as metrics buffer 2704, that is used exclusively by the metrics-collector thread or process with which it is associated. The set of metrics buffers 2706 is protected by a write/read-write lock 2708, referred to as the “WR lock.” The WR lock allows each of the multiple metrics-collector threads or processes to access the metrics buffer assigned to the metrics-collector thread or process simultaneously and concurrently with access by other of the multiple metrics-collector threads or processes to their associated metrics buffers. However, when the metrics aggregator 2710, in the case of a single-threaded, non-distributed metrics aggregator, acquires the WR lock, or when any thread or process of a multi-threaded or distributed metrics aggregator acquires the WR lock, all other processes and threads are excluded from accessing any of the metrics buffers. Because multiple metrics-collector threads or processes are allowed to concurrently and simultaneously append metrics messages to their metrics buffers, the high rate of contention for lock 2514 in FIG. 25, in the previously discussed implementation, is avoided. The implementation of the local metrics collector and local metrics aggregator shown in FIG. 27A combined with the final improved architecture shown in FIG. 24B constitutes one implementation of the currently disclosed methods and systems. The metrics-collection-and-aggregation system represented by this implementation achieves a scalable, high rate of metrics-message collection and processing by avoiding unnecessary lock contention and unnecessary high volumes of network traffic while minimizing the volume of data stored in the distributed database of the management Tanzu cluster in response to the collected metrics messages.

FIG. 27B illustrates an example implementation of a metrics-collector thread or process. The metrics-collector thread or process 2720 includes network-interface logic 2722, a circular metrics-message input buffer 2724, and metrics-collector logic 2726. A metrics message 2728 is received by the network interface logic 2722 and queued to the circular metrics-message input buffer inputQ 2724. The metrics-collector logic 2726 dequeues metrics messages from the inputQ, acquires the WR lock, writes the dequeued metrics message to the metrics buffer associated with the metrics-collector thread or process, and then releases the WR lock. In certain implementations, the metrics-collector logic may acquire the WR lock, dequeue and append all or up to some maximum number of the metrics messages currently stored in the inputQ, and then release the WR lock. The inputQ acts as a buffer to allow the metrics-collector thread or process to continue to receive metrics messages while the metrics-collector thread or process is waiting to acquire the WR lock, to avoid dropping metrics messages and/or resending metrics messages by the service proxies within the client Kubernetes cluster.

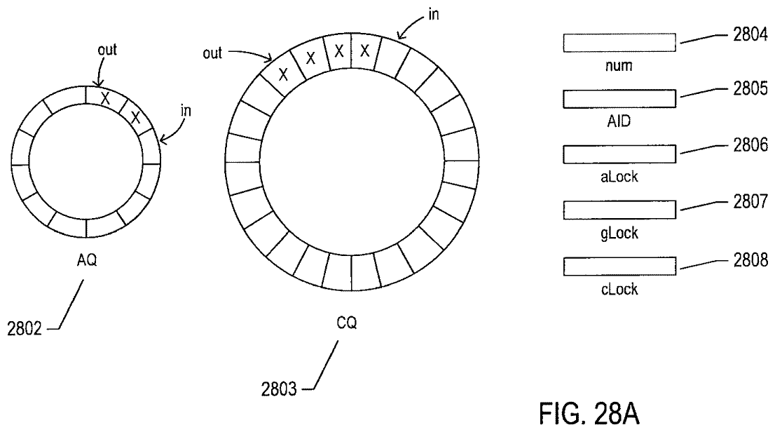

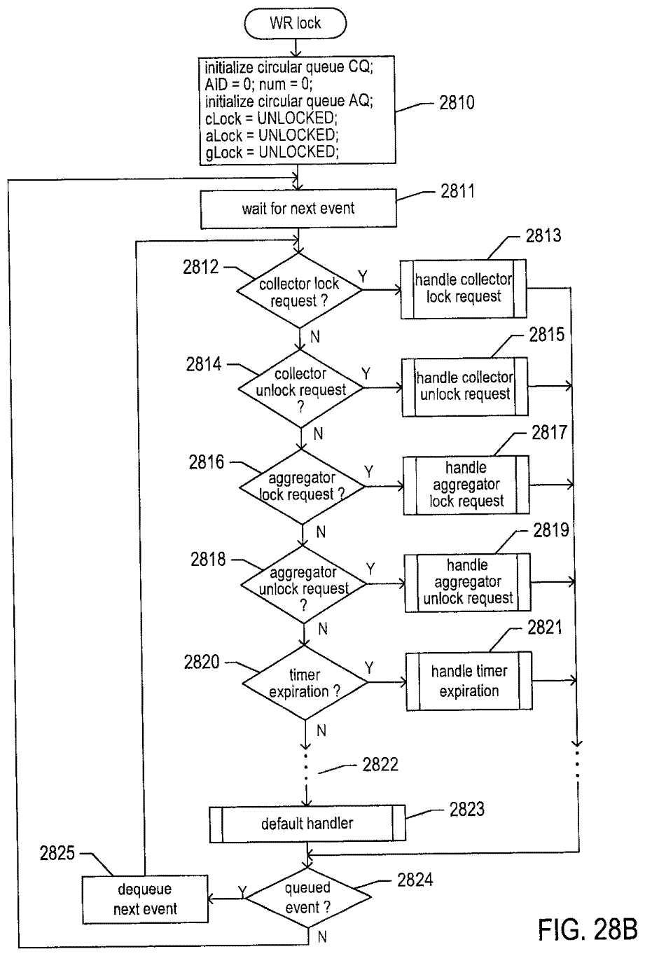

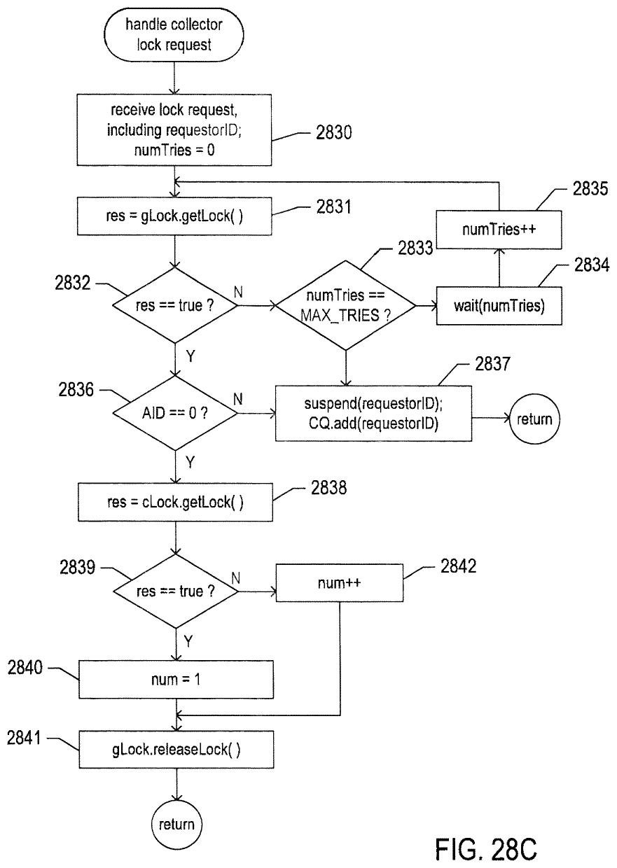

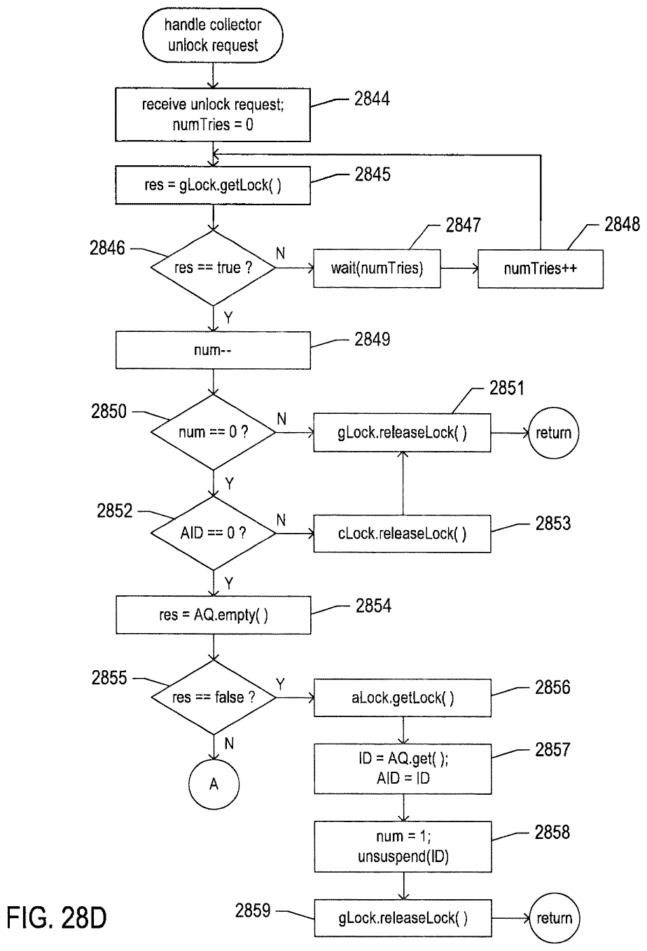

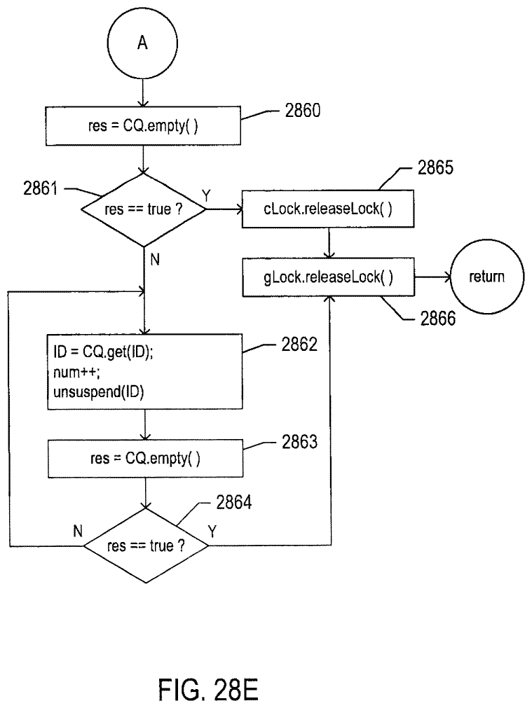

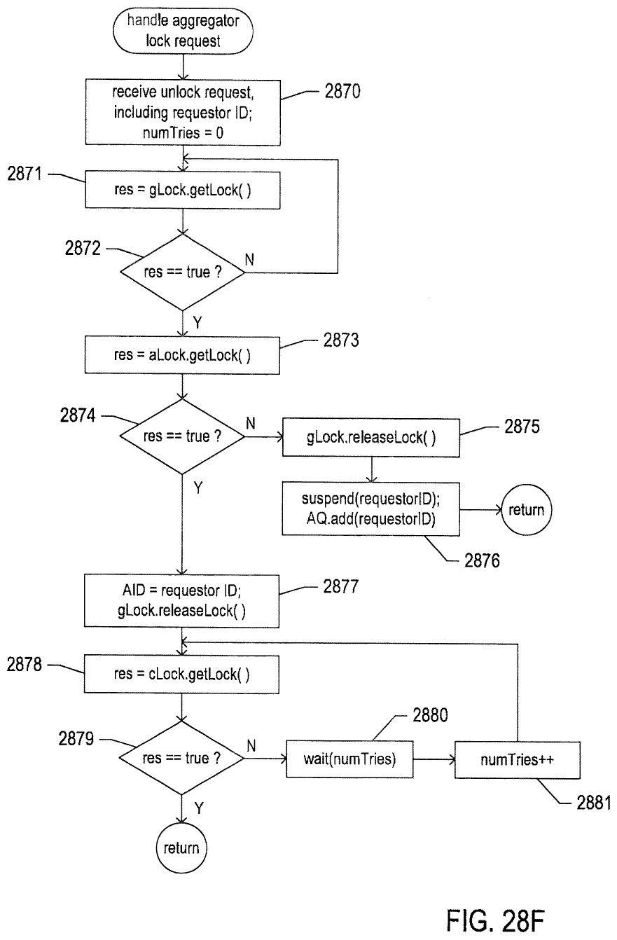

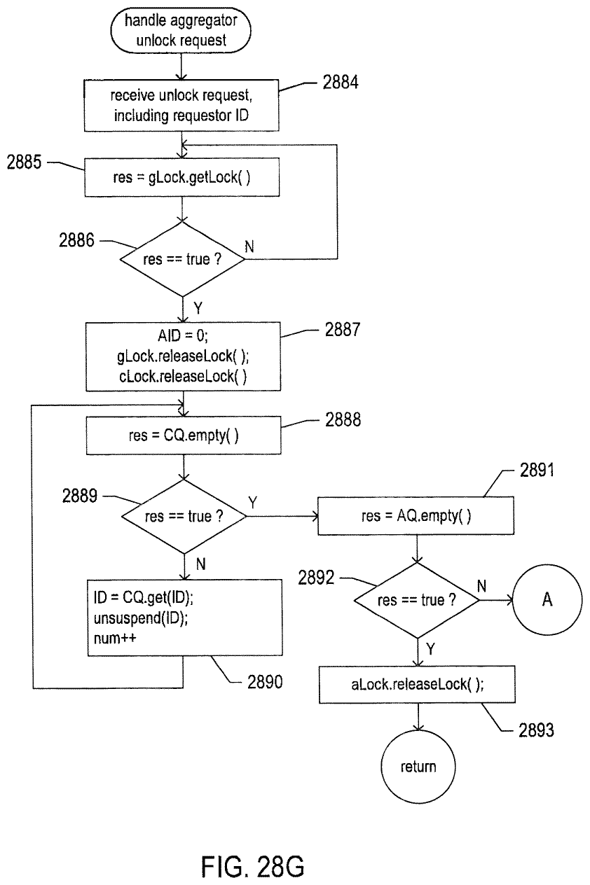

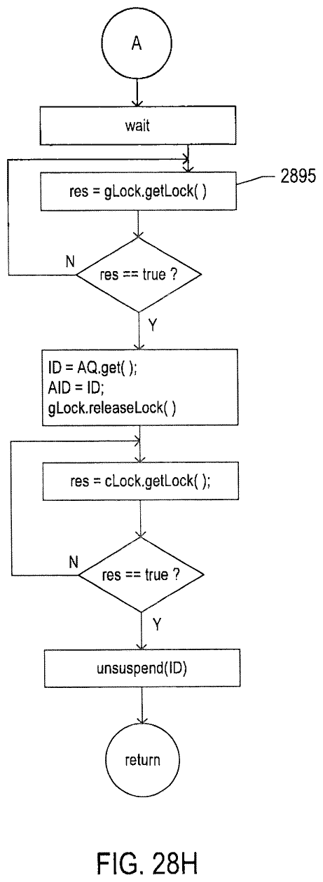

FIGS. 28A-H illustrate, using control-flow diagrams, one implementation of the WR lock. FIG. 28A shows several data structures and variables used in the implementation of the WR lock. These include: (1) an aggregator circular queue (“AQ”) 2802, which stores process or thread IDs for aggregator threads or processes: (2) a collector circular queue (“CQ”) 2803, which stores process or thread IDs for collector threads or processes; (3) a variable num 2804, which stores the number of collectors currently accessing their associated metrics buffers; (4) a variable AID 2805, which stores the process or thread ID for an aggregator currently holding an aggregator lock aLock; (5) the aggregator lock aLock 2806, one of three locks used for implementation of the WR lock; (6) a global lock gLock 2807; and (7) a collector lock cLock 2808.

FIG. 28B provides an initial control-flow diagram that includes an underlying event loop for the implementation of the WR lock. In step 2810, the WR lock initializes the two circular queues AQ and CQ, initializes the variables AID and num to 0, and initializes the three locks aLock, gLock, and cLock to the value UNLOCKED. Then, in step 2811, the WR lock waits for the occurrence of a next event. When the next event is a lock request from a collector, as determined in step 2812, a collector-lock-request handler is called in step 2813. When the next event is an unlock request from a collector, as determined in step 2814, a collector-unlock-request handler is called, in step 2015. When the next event is a lock request from an aggregator, as determined in step 2816, an aggregator-lock-request handler is called in step 2817. When the next request is an unlock request from an aggregator, as determined in step 2818, an aggregator-unlock-request handler is called in step 2819. When the next event is a timer expiration, as determined in step 2820, a timer-expiration handler is called in step 2821. The timer-expiration handler is one example of logic that can be included in the implementation of the WR lock to detect various types of errors, such as crashes of collectors or aggregators holding the WR lock. These specialized error-detection and error-correction handlers and logic are not further discussed. Ellipsis 2022 indicates that other types of events may be handled by the WR lock event handler. A default handler is called, in step 2823, to handle any rare or unexpected events. When there are one or more events queued for handling, as determined in step 2824, a next event is dequeued, in step 2825, and control returns to step 2812. Otherwise, control returns to step 2011, where the WR lock waits for the occurrence of a next event.

FIG. 28C provides a control-flow diagram for the collector-lock-request handler called in step 2813 of FIG. 28B. In step 2830, the collector-lock-request handler receives the lock request, including the requestor ID of the requesting metrics collector, and sets a local variable numTries to 0. In step 2831, the collector-lock-request handler calls the getLock( ) method for the global lock gLock. The global lock single-threads certain critical sections in the WR-lock logic. When the getLock( ) method fails to return the Boolean value true, as determined in step 2832, and when the value stored in local variable numTries is not equal to a constant value MAX_TRIES, as determined in step 2833, the collector-lock-request handler calls a wait routine, in step 2834, which suspends execution of the collector-lock-request handler for a short period of time that depends on the current value of the local variable numTries and then increments the local variable numTries, in step 2835, after which control flows back to step 2831, where the collector-lock-request handler again attempts to acquire the lock gLock. In certain implementations, the wait routine may implement an exponential backoff routine. Once the lock gLock is acquired, as determined in step 2832, the collector-lock-request handler determines, in step 2836, whether the local variable AID is currently storing an aggregator process or thread ID. If so, then, in step 2837, the collector-lock-request handler suspends execution of the requesting collector process or thread and adds the requestor ID to the CQ. The collector-lock-request handler may also reach step 2837 after failing to acquire the lock gLock following MAX_TRIES attempts, as determined in step 2833. When the local variable AID is not currently storing an aggregator process or thread ID, as determined in step 2836, then, in step 2838, the collector-lock-request handler calls the getLock( ) method for the metrics-collector lock cLock. When the call to the getLock( ) method returns a Boolean value true, as determined in step 2839, then no other collector is currently holding the metrics-collector lock cLock and, therefore, the collector-lock-request handler sets the variable num to 1, in step 2840, and releases the global lock in step 2841 before returning, allowing the requesting collector thread or process to proceed after having acquired the metrics-collector lock cLock. When the call to the getLock( ) method returns a Boolean value false, as determined in step 2839, the collector-lock-request handler increments the variable num, in step 2842, after which control flows to step 2841, where the global lock is released. In this case, at least one other collector is currently holding the metrics-collector lock cLock, but the WR lock allows multiple collectors to simultaneously hold the cLock and access the metrics buffers associated with the multiple collectors.

FIGS. 28D-E provide control-flow diagrams for the collector-unlock-request handler called in step 2815 of FIG. 28B. In step 2844, the collector-unlock-request handler receives an unlock request and sets the local variable numTries to 0. Then, in steps 2045-2848, the collector-unlock-request handler acquires the global lock in a similar fashion to acquisition of the global lock in steps 2831-2835 in FIG. 28C. In this case, the collector-unlock-request handler continues to call the getLock( ) method for the global lock, in step 2045, until the global lock is acquired. Once acquired, the collector-unlock-request handler decrements the local variable num, in step 2849. If the local variable num does not contain the value 0, as determined in step 2850, the collector-unlock-request handler releases the global lock, in step 2851, and returns. In this case, there are other metrics collectors holding the collector lock cLock. Otherwise, the collector-unlock-request handler calls the empty( ) method of AQ, in step 2854, to determine whether an aggregator thread or process ID is currently stored in local variable AID. If an aggregator thread or process ID is currently stored in local variable AID, then the collector-unlock-request handler releases the collector lock cLock, in step 2853, and then releases the global lock before returning. When there is an aggregator thread or process ID currently stored in local variable AID, then the aggregator thread or process is waiting to acquire the collector lock cLock and, therefore, the last collector that held the collector lock cLock, which is the current requesting collector, needs to release collector lock cLock. When there is no aggregator thread or process ID currently stored in local variable AID, as determined in step 2852, the collector-unlock-request handler calls the AQ method empty( ) to determine whether AQ is empty, in step 2854. If AQ is not empty, as determined in step 2855, then there is an aggregator process or thread waiting to acquire the aggregator lock aLock. Therefore, the collector-unlock-request handler acquires the aggregator lock, in step 2856, dequeues the process or thread ID of the next, waiting aggregator from AQ, places the process or thread ID into variable AID, in step 2857, sets local variable num to 1, since the aggregator will be the only holder of the collector lock cLock, unsuspends the aggregator process or thread, in step 2858, and releases the global lock in step 2859 before returning. Otherwise, when A Q is empty, as determined in step 2855, then, in step 2860, at the top of FIG. 28E, the collector-unlock-request handler calls the empty( ) method of the collector lock cLock to determine whether or not there are any collectors waiting to acquire the collector lock cLock. If there are collectors waiting to acquire the collector lock cLock, as determined in step 2861, the collectors are dequeued from CQ, in the loop of steps 2862-2864. If there are no collectors waiting to acquire the collector lock cLock, as determined in step 2861, the collector-unlock-request handler releases the collector lock cLock in steps 2865 and 2866 prior to returning. The global lock is released in step 2866 following completion of the loop of steps 2862-2864, as well.

FIG. 28F provides a control-flow diagram for the aggregator-lock-request handler called in step 2817 of FIG. 28B. In step 2870, the aggregator-lock-request handler receives the lock request, including a requestor ID, and sets the local variable numTries to 0. The aggregator-lock-request handler then acquires the global lock in steps 2871-2872. In step 2873, the aggregator-lock-request handler calls the getLock( ) member of the aggregator lock aLock. When the call to the getLock( ) member of the aggregator lock aLock fails, as determined in step 2874, the aggregator-lock-request handler releases the global lock, in step 2875, and then suspends the requesting aggregator process or thread and adds the requestor ID to AQ in step 2876, before returning. When the call to the getLock( ) member of the aggregator lock aLock succeeds, as determined in step 2874, the aggregator-lock-request handler sets local variable AID to the requestor ID, releases the global lock, in step 2877, and then acquires the collector lock cLock, in steps 2878-2881, before returning.

FIGS. 28G-H provide control-flow diagrams for the aggregator-unlock-request handler, called in step 2819 of FIG. 28B. In step 2884, the aggregator-unlock-request handler receives the unlock request, including a requestor ID. The aggregator-unlock-request handler then acquires the global lock, in steps 2885-2886. In step 2887, the aggregator-unlock-request handler sets local variable AID to 0 and releases the global lock and the collector lock cLock. In steps 2888-2890, the aggregator-unlock-request handler dequeues and resumes execution of any collectors waiting in the CQ for the collector lock cLock and then, in step 2891, calls the AQ method empty( ). If there are no aggregator processes or threads waiting for the aggregator lock in the AQ, as determined in step 2892, the aggregator-unlock-request handler releases the collector lock cLock, in step 2893, and releases the global lock, in step 2894. Otherwise, in step 2895 at the top of FIG. 28H, the aggregator-unlock-request handler waits, to allow a number of collector threads or processes to access their associated metrics buffers and then, in the remaining steps of FIG. 28H, reacquires the global lock, dequeues the next waiting aggregator process or thread from AQ, sets AID, and reacquires the collector lock cLock before resuming execution of the dequeued aggregator process or thread.

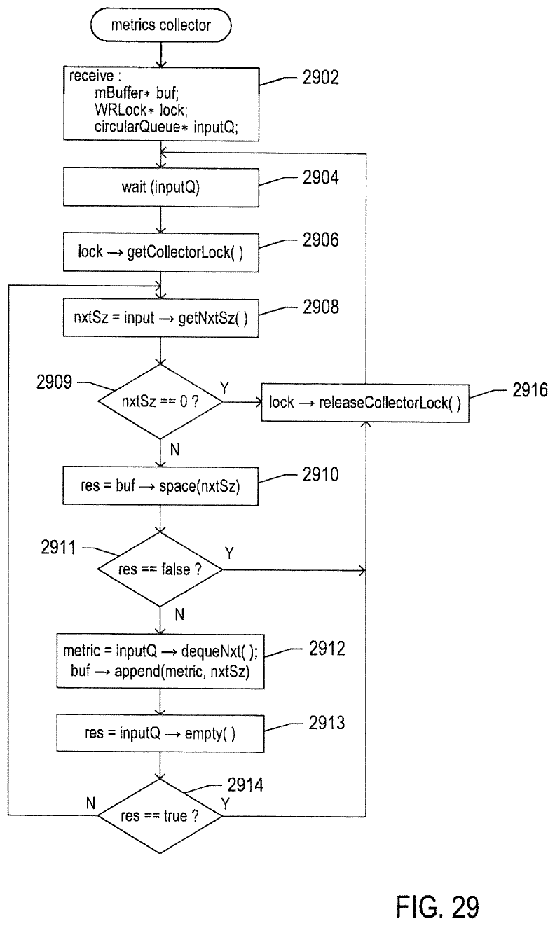

FIG. 29 provides a control-flow diagram for the metrics-collector logic (2726 in FIG. 27B). In step 2902, the metrics collector receives a reference to a metrics buffer, a reference to the WR lock, and a reference to the input queue inputQ (2724 in FIG. 27B). Then, in step 2904, the metrics collector waits for an input event generated by inputQ. When an input event occurs, the metrics collector acquires the WR lock, in step 2906, and then, in the loop of steps 2908-2914, dequeues metric messages from inputQ and appends them to the metrics buffer. When all of the metrics messages have been dequeued from inputQ or when there is insufficient room in the metrics buffer for another metrics message, the metrics collector releases the WR lock, in step 2916, and returns to step 2904 to wait for another input event.

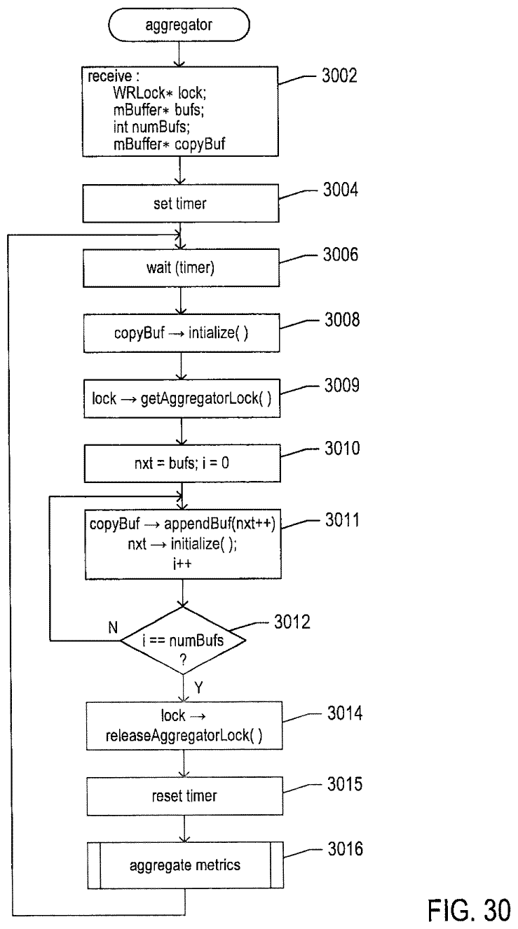

FIG. 30 provides a control-flow diagram for the aggregator logic. In step 3002, the aggregator receives a reference to the WR lock, a reference to the set of metrics buffers (2706 in FIG. 27A), a reference to the copy buffer used to store metrics messages extracted from the metrics buffers, and an indication of the number of metrics buffers. In step 3004, the aggregator sets a timer and then, in step 3006, waits for the timer to expire. In step 3008, the aggregator initializes the copy buffer and, in step 3009, acquires the WR lock. In the loop of steps 3010-3012, the aggregator copies the metrics buffers into the copy buffer. In step 3014, the aggregator releases the WR lock and then, in step 3015, resets the timer. In step 3016, the aggregator calls a routine “aggregate metrics” to generate aggregated metrics from the metric messages stored in the copy buffer and transmits the aggregated metrics to the management Tanzu cluster.

The present invention has been described in terms of particular embodiments, it is not intended that the invention be limited to these embodiments. Modifications within the spirit of the invention will be apparent to those skilled in the art. For example, any of many different implementations of the currently disclosed methods and systems can be obtained by varying various design and implementation parameters, including modular organization, control structures, data structures, hardware, operating system, and virtualization layers, automated orchestration systems, virtualization-aggregation systems, and other such design and implementation parameters.

1. A distributed computer system comprising:
a management distributed computer system that receives aggregated metrics messages from one or more client distributed computer systems; and
a client distributed computer system that includes
multiple metrics collectors, each metrics collector receiving and appending metrics messages to a metrics buffer associated with the metrics collector to which only the metrics collector appends metrics messages,
one or more aggregators that
copy metrics from the metrics buffers associated with metrics collectors into a copy buffer,
aggregate metrics messages within the copy buffer, and
transmit aggregated metrics messages to the management distributed computer system, and
a write/read-write lock that controls contention for the metrics buffers associated with the multiple metrics collectors.

2. The distributed computer system of claim 1 wherein the management distributed computer system stores the received aggregated metrics messages in a distributed database and subsequently uses the aggregated metrics messages to manage the client distributed computer system.

3. The distributed computer system of claim 1 wherein the client distributed computer system comprises multiple execution environments, each implemented on one or more physical or virtual servers, that support execution of services and applications.

4. The distributed computer system of claim 3 wherein each execution environment includes a service proxy that
receives service calls from applications;
forwards the received service calls to services;
receives responses to forwarded service calls from services; and
returns the received responses to the applications and transmits a metrics message to one of the metrics collectors.

5. The distributed computer system of claim 1 wherein a metrics message includes:
a timestamp;
a source field that contains an indication of the source of a service call;
a service field that contains an indication of a service to which the service call was directed; and
one or more metric fields that each contains a value from which a metric value is derived.

6. The distributed computer system of claim 5 wherein a set of metrics messages is aggregated to generate a corresponding aggregated metrics message by:
selecting one or more fields as aggregation fields;
for each aggregation field, selecting a set of classes or quantized values for the metric value derived from the field;
partitioning the set of metrics messages into one or more subsets, based on values of the fields in the metrics messages not selected as aggregation fields; and
representing each subset of metrics messages by an aggregated metrics message that includes a count field for each class or quantized value.

7. The distributed computer system of claim 1 wherein the write/read-write lock provides:
a collector-lock method;
a collector-unlock method;
an aggregator-lock method; and
an aggregator-unlock method.

8. The distributed computer system of claim 7
wherein multiple metrics collectors can acquire and concurrently hold the write/read-write lock by calling the collector-lock method; and
wherein no aggregator can acquire the write/read-write lock when one or more metrics collectors currently hold the write/read-write lock.

9. The distributed computer system of claim 8
wherein, when an aggregator currently holds the write/read-write lock, execution of a metrics collector that calls the collector-lock method is suspended until the write/read-write lock becomes available for acquisition to metrics collectors.

10. The distributed computer system of claim 8
wherein one aggregator can acquire and concurrently hold the write/read-write lock by calling the aggregator-lock method; and
wherein no additional aggregator can acquire or hold the write/read-write lock when an aggregator currently holds the write/read-write lock.

11. The distributed computer system of claim 10
wherein, when an aggregator or one or more metrics collectors currently holds the write/read-write lock, execution of an aggregator that calls the aggregator-lock method is suspended until the write/read-write lock becomes available for acquisition to aggregators.

12. The distributed computer system of claim 10
wherein, when one or metrics collectors concurrently hold the write/read-write lock and an aggregator calls the aggregator-lock method an execution of the aggregator is suspended, additional metrics collectors cannot acquire and hold the write/read-write lock until the suspended aggregator acquires and holds the write/read-write lock.

13. The distributed computer system of claim 1
wherein each metrics collector, following initialization, waits to receive metrics messages; and
wherein, when a metrics collector has received at least one metrics message, the metrics collector
calls a collector-lock method of the write/read-write lock to acquire and hold the write/read-write lock,
appends one or more received metrics messages to the metrics buffer associated with the metrics collector, and
calls a collector-unlock method of the write/read-write lock to release the write/read-write lock.

14. The distributed computer system of claim 1
wherein an aggregator, following initialization, waits for a next aggregation time interval to begin; and
wherein, when a next aggregation time interval has begun, the aggregator
calls an aggregator-lock method of the write/read-write lock to acquire and hold the write/read-write lock,
copies metrics messages from the metrics buffers associated with the metrics collectors into a copy buffer,
reinitializes the metrics buffers associated with the metrics collectors,
calls an aggregator-unlock method of the write/read-write lock to release the write/read-write lock,
aggregates metrics messages in the copy buffer to generate one or more aggregated metrics messages, and
transmits the one or more aggregated metrics messages to the first distributed computer system.

15. A method that collects metrics messages from a client distributed computer system, aggregates the collected metrics messages to generate one or more aggregated metrics messages, and transmits the one or more aggregated metrics messages to a management distributed computer system, the method comprising:
providing, in the client distributed computer system, multiple metrics collectors and one or more aggregators;
initializing the multiple metrics collectors and one or more aggregators;
receiving, by each metric collector, metrics messages and appending the received metrics messages to a metrics buffer associated with the metrics collector and to which only the metrics collector appends metrics messages; and
periodically
copying, by an aggregator, metrics from the metrics buffers associated with metrics collectors into a copy buffer,
aggregating, by the aggregator, metrics messages within the copy buffer to generate one or more aggregated metrics messages, and
transmitting, by the aggregator, the one or more aggregated metrics messages to the management distributed computer system.

16. The method of claim 15 further comprising:
storing, by the management distributed computer system, received aggregated metrics messages in a distributed database; and
using the stored aggregated metrics messages to manage the one or more client distributed computer systems.

17. The method of claim 15 further comprising:
providing a write/read-write lock to control contention for metrics buffer by the multiple metrics collectors and one or more aggregators; and
wherein the write/read-write lock provides
a collector-lock method,
a collector-unlock method,
an aggregator-lock method, and
an aggregator-unlock method.

18. The method of claim 17
wherein multiple metrics collectors can acquire and concurrently hold the write/read-write lock by calling the collector-lock method;
wherein no aggregator can acquire the write/read-write lock when one or more metrics collectors currently holds the write/read-write lock;
wherein, when an aggregator currently holds the write/read-write lock, execution of a metrics collector that calls the collector-lock method is suspended until the write/read-write lock becomes available for acquisition to metrics collectors;
wherein one aggregator can acquire and concurrently hold the write/read-write lock by calling the aggregator-lock method;
wherein no additional aggregator can acquire or hold the write/read-write lock when an aggregator currently holds the write/read-write lock;
wherein, when an aggregator or one or more metrics collectors currently holds the write/read-write lock, execution of an aggregator that calls the aggregator-lock method is suspended until the write/read-write lock becomes available for acquisition to aggregators; and
wherein, when one or metrics collectors concurrently hold the write/read-write lock and an aggregator calls the aggregator-lock method an execution of the aggregator is suspended, additional metrics collectors cannot acquire and hold the write/read-write lock until the suspended aggregator acquires and holds the write/read-write lock.

19. The method of claim 17
wherein each metrics collector, following initialization, waits to receive metrics messages;
wherein, when a metrics collector has received at least one metrics message, the metrics collector
calls a collector-lock method of the write/read-write lock to acquire and hold the write/read-write lock,
appends one or more received metrics messages to the metrics buffer associated with the metrics collector, and
calls a collector-unlock method of the write/read-write lock to release the write read-write lock;
wherein an aggregator, following initialization, waits for a next aggregation time interval to begin; and
wherein, when a next aggregation time interval has begun, the aggregator
calls an aggregator-lock method of the write/read-write lock to acquire and hold the write/read-write lock,
copies metrics messages from the metrics buffers associated with the metrics collectors into a copy buffer,
reinitializes the metrics buffers associated with the metrics collectors,
calls an aggregator-unlock method of the write/read-write lock to release the write/read-write lock,
aggregates metrics messages in the copy buffer to generate one or more aggregated metrics messages, and
transmits the one or more aggregated metrics messages to the first distributed computer system.

20. A physical data-storage device encoded with computer instructions that, when executed by computational resources of a distributed computer system, controls the distributed computer system to:
initialize multiple metrics collectors and one or more aggregators;
initialize a write/read-write lock to control contention for metrics buffers;
receive, by each metrics collector, metrics messages;
append, by each metrics collector, the received metrics messages to a metrics buffer associated with the metrics collector and to which only the metrics collector appends metrics messages;
periodically copying, by an aggregator, metrics from the metrics into a copy buffer,
aggregating, by the aggregator, metrics messages within the copy buffer to generate one or more aggregated metrics messages, and
transmitting, by the aggregator, the one or more aggregated metrics messages to the management distributed computer system.
